(19) United States
(12) Patent Application Publication
(10) Pub. No.: US 2014/0331118 A1
(43) Pub. Date: Nov. 6, 2014

(54) Persisting Objects in a Single Data Table

(71) Applicant: SAP AG, Walldorf (DE)

(72) Inventors: Martin Helm, Bad Schoenborn (DE); Martin Moser, Speyer (DE)

(73) Assignee: SAP AG, Walldorf (DE)

(21) Appl. No.: 13/888,163

(22) Filed: May 6, 2013

(51) Int. Cl. G06F 17/22

(52) U.S. Cl. CPC G06F 17/2247
USPC 715/234

(57) ABSTRACT

Disclosed is a system and method for persisting software objects. An object may be scanned to identify the members of the object. The members are transformed into an intermediate data structure. The intermediate data structure may be persisted in a single data table. Subsequent objects may be similarly scanned into respective intermediate data structure, and then persisted in the same single data table.

### CROSS REFERENCE TO RELATED APPLICATIONS

The present disclosure relates to U.S. patent application Ser. No. 11/023,917 filed Dec. 27, 2004, the content of which is incorporated herein by reference in its entirety for all purposes.

### BACKGROUND

Unless otherwise indicated herein, the approaches described in this section are not prior art to the claims in this application and are not admitted to be prior art by inclusion in this section.

The term “persistence” refers to storing information on non-volatile media such as a database. Object persistence refers to persistently storing objects that are written in accordance with an object-oriented programming language such as Java. The term “Java persistence” is often used as a convenient way to describe persistently storing Java objects. Conventional approaches to Java persistence include Java Data Objects, object serialization, and bytecode rewriting.

The term “Java Data Objects (JDO)” refers to a persistency technology based, at least in part, on one of the JDO specifications such as Java Specification Request (JSR)-000012 entitled, “The Java Data Objects (JDO) Specification.” The JDO specification specifies a mechanism for transparently persisting Java objects. Transparently persisting Java objects means that the software that is used to access and modify the fields of an object follows the standard practice used in most Java applications. In order to implement JDO, however, it is necessary to identify which classes should be persistent. JDO uses a metadata file formatted in the eXtensible Mark Language (XML) to identify persistent classes.

Object serialization is a mechanism for writing the state of an object (and a graph of the objects it references) to a serial output stream. The serial output stream is written to a destination such as a file. The serial stream can be read from the file to reconstruct the object. Object serialization requires that each object implement a particular interface. For example, Java serialization based on the java.io.Serializable package requires that all serializable objects implement the interface java.io.Serializable.

Bytecode rewriting is directed to rewriting Java classes as they are loaded to a Java Virtual Machine (JVM). When the JVM detects a reference to an unloaded class, it sends a request to a class loader to load the class from the file system. In standard Java, the class is loaded directly to the JVM. In bytecode rewriting, however, a bytecode transformer is invoked to transform the class before it is loaded. The bytecode transformer can modify the class to add persistence logic.

These conventional approaches to Java persistence each impose a precondition on persistent objects. For example, object serialization requires that persistent objects implement a serializable interface. Similarly, JDO technology involves describing persistent objects with a JDO metadata file. Object persistency based on bytecode rewriting involves post-processing object bytecode.

### BRIEF DESCRIPTION OF THE DRAWINGS

Embodiments in accordance with the present disclosure are illustrated by way of example, and not by way of limitation, in the figures of the accompanying drawings in which like reference numerals refer to similar elements.

FIG. 1 is a block diagram of selected elements of a persistence system implemented according to an embodiment in accordance with the present disclosure.

FIG. 2 is a block diagram illustrating the structure of an object store Application Program Interface (API), according to an embodiment in accordance with the present disclosure.

FIG. 3 illustrates a number of persistency methods used by the object store API, according to an embodiment in accordance with the present disclosure.

FIG. 4 illustrates the process of generating an intermediate data structure, according to an embodiment in accordance with the present disclosure.

FIG. 5 illustrates a simplified coding example for locating an appropriate constructor for instantiating a class, according to an embodiment in accordance with the present disclosure.

FIG. 6 is a block diagram illustrating the structure of a persistence manager API, according to an embodiment in accordance with the present disclosure.

FIG. 7 illustrates the persistency methods of the persistence manager API, according to an embodiment in accordance with the present disclosure.

FIG. 8 illustrates a configuration file according to an embodiment in accordance with the present disclosure.

FIG. 9 is a flow diagram illustrating certain aspects of a method for persisting an object according to an embodiment in accordance with the present disclosure.

FIG. 10 is a flow diagram illustrating certain aspects of a method for persisting an object according to a particular embodiment in accordance with the present disclosure.

FIGS. 11A and 11B show an example of objects and instances of the objects.

FIGS. 12A, 12B, 12C, and 12D are examples of intermediate data structures that represent the object instances of FIG. 11B.

FIGS. 12E, 12F, 12G, 12H, and 12I are examples of intermediate data structures for storing strings which occur in the object instances of FIG. 11B.

FIG. 13 illustrates an example of a data table.

### DETAILED DESCRIPTION

Embodiments in accordance with the present disclosure are generally directed to a system and method for persisting objects and object closures. In contrast to conventional persistency solutions, embodiments in accordance with the present disclosure do not impose preconditions or requirements on persistent objects. In an embodiment, objects are scanned with object introspection to identify the members of the object. Introspection refers to the process of inspecting objects to obtain metadata about the objects. The term “dynamic introspection” refers to examining metadata of classes that are already loaded into a virtual machine (e.g., a Java Virtual Machine (JVM)). The members are transformed and stored into an intermediate data structure via a recursive scan and transformation algorithm. The functions of the scan and transformation algorithm can be influenced by a set of rules that allow, for example, avoiding a recursive scan of certain members and/or skipping other members altogether. The term “transform” refers to using an algorithm to determine how a member is represented in the intermediate data structure. The rules allow for the exclusion of parts of an object closure from the recursive scan and transformation. If the object references another object, then the process is repeated recursively on the other object. Thus, in an embodiment, an entire object closure may be scanned and transformed into the intermediate data structure. The intermediate data structure is persisted in a data store.

In an embodiment, a handle is returned when an object is stored. A handle is a Java object similar to a data base key, such that it uniquely identifies the stored object in the embodiment. In contrast to a data base key a handle is opaque, meaning that only the embodiment knows the exact implementation of a handle and can therefore manipulate it. Handles do not have any methods and applications cannot manipulate them; all they can do is pass handles on to the embodiment for processing. An object's handle can be used, for example, to retrieve the object from the embodiment. Handles themselves can also be stored in the embodiment, for example for bootstrapping purposes. To later retrieve such a handle from the embodiment, the handle must be stored under a unique name, which can be an arbitrary string. Handles that are stored under a name are also called “named handles”.

When an object is stored in the embodiment, not only the object itself, but also all objects that can be accessed from the object are also stored. A first object can be accessed from a second object if the second object either holds a reference to the first object, or the second object holds a reference to a third object, from which the first object can be accessed. The set of all objects that can be accessed from an object is called the object's closure, while the object is called the closure's anchor object. (Note that an object closure can have more than one anchor object, while not every object in a closure is also an anchor object of the closure.)

Finally, objects must be reachable in order to be retrieved from the embodiment. Per definition, all objects referenced by named handles are reachable. Further, all objects that can be accessed from reachable objects are reachable. All objects that are not reachable are called unreachable. Unreachable objects fill the database with no use. Such, they are removed during the data base garbage collection.

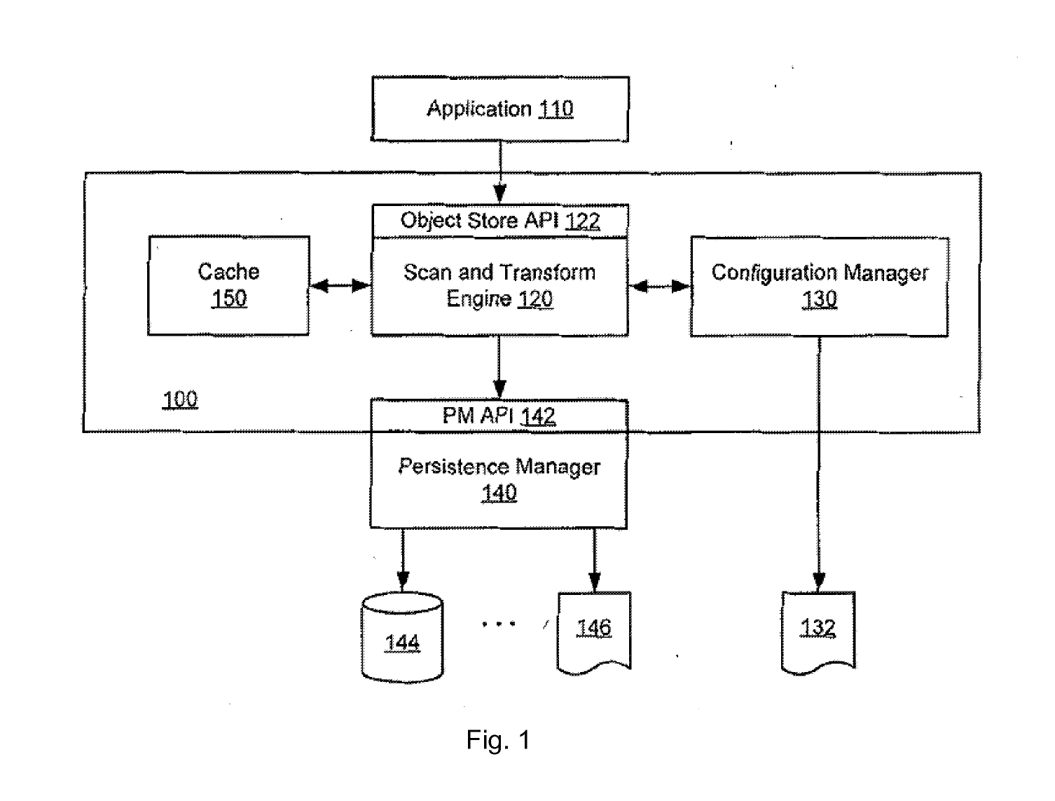

FIG. 1 is a block diagram of selected elements of a persistence system 100 implemented according to an embodiment in accordance with the present disclosure. Persistence system 100 stores and retrieves objects and object closures for one or more applications such as application 110. The term “object closure” refers to a set of Java objects containing at least one reachable object and zero or more objects that are transitively referenced by the reachable object. A reachable object is an object that can be retrieved either directly or indirectly from, for example, persistence system 100. As is further described below, in an embodiment, a “named handle” is a starting point for retrieving objects. An object can be retrieved directly using its handle (as is further described below). An object can be retrieved indirectly as part of an object closure. Objects that are not reachable are called unreachable. Persistence system 100 treats a single object as the special case of a one element object closure. Consequently, when referring to object closures in the text below, the single object case is subsumed even if it is not specifically mentioned. In addition, embodiments in accordance with the present disclosure are described with reference to Java objects. It is to be appreciated that alternative embodiments may be directed to persisting objects written in other programming languages.

In an embodiment, persistence system 100 is part of a multi-tiered network. The multi-tiered network may be implemented using a variety of different application technologies at each of the layers of the multi-tier architecture, including those based on the Java 2 Enterprise Edition™ (“J2EE”) specification (e.g., the Websphere platform developed by IBM Corporation), the Microsoft .NET platform, and/or the Advanced Business Application Programming (“ABAP”) platform developed by SAP AG. The J2EE specification refers to any of the J2EE specifications including, for example, the Java 2 Enterprise Edition Specification v1.3, published on Jul. 27, 2001. None of these technologies, however, are required by an embodiment in accordance with the present disclosure.

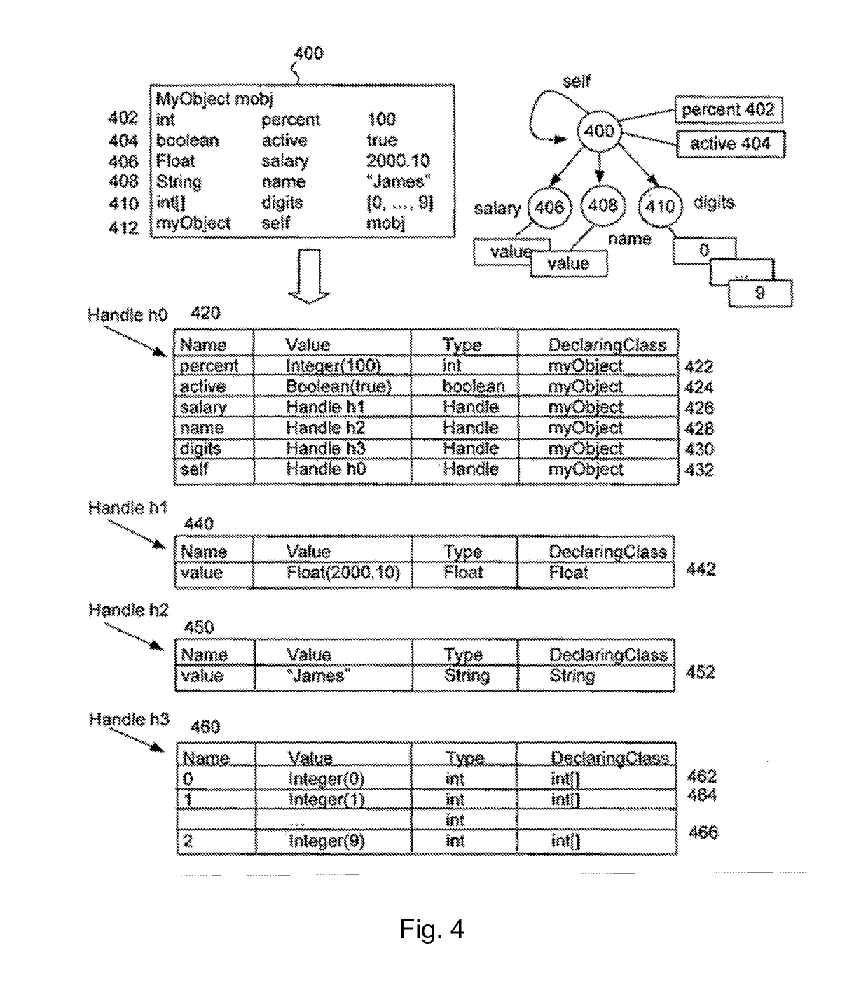

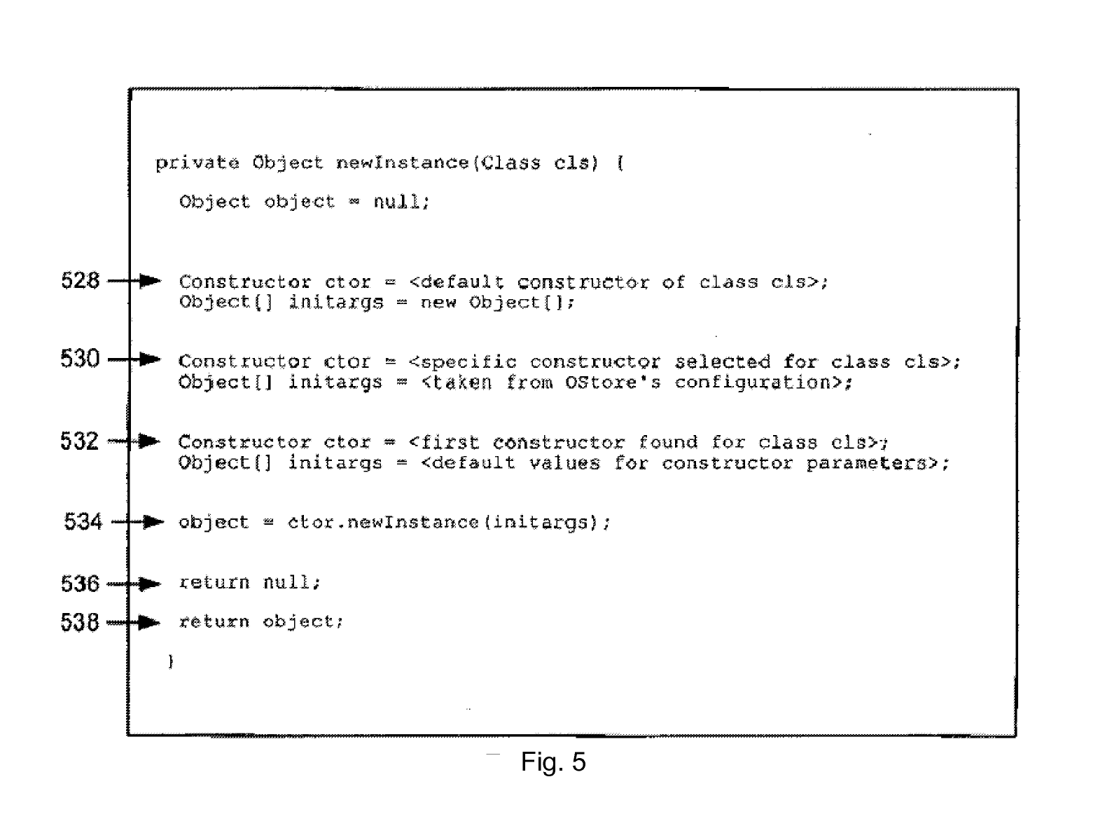

Persistence system 100 includes Scan and Transform Engine (STE) 120, object store Application Program Interface (API) 122, configuration manager 130, persistence manager API 142, and cache 150. In alternative embodiments, persistence system 100 includes more elements, fewer elements, and/or different elements. STE 120 uses introspection to scan and transform object closures. The transformed object closure is stored in an intermediate data structure and passed to persistence manager 140. STE 120 is further discussed below with reference to FIG. 4 through FIG. 5.

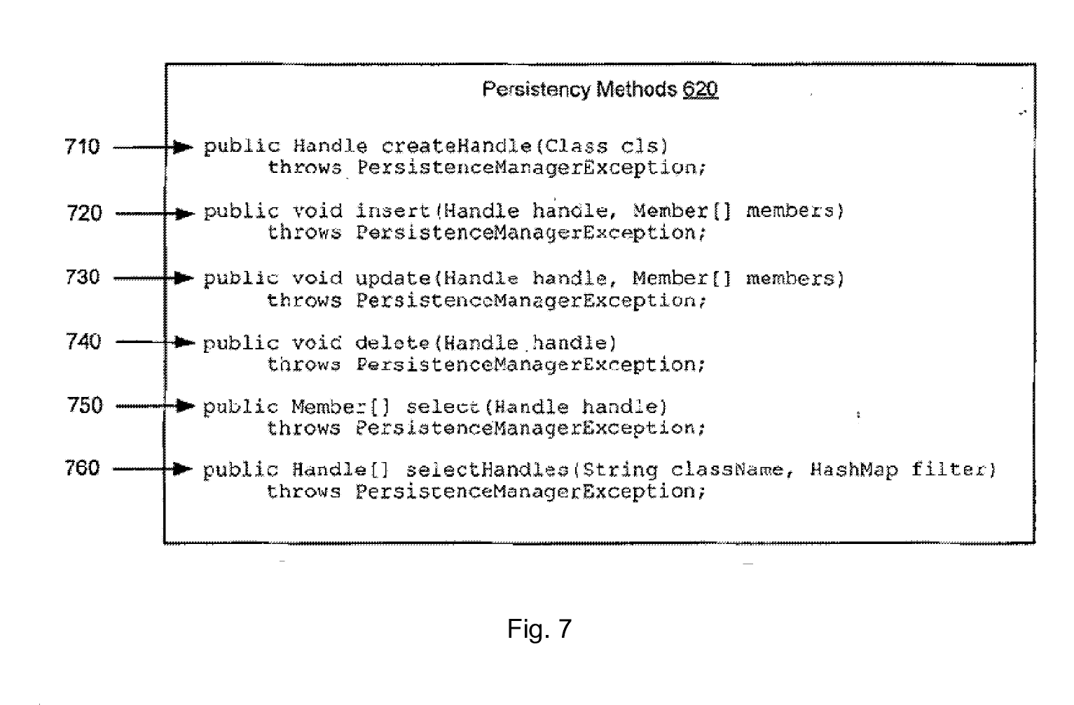

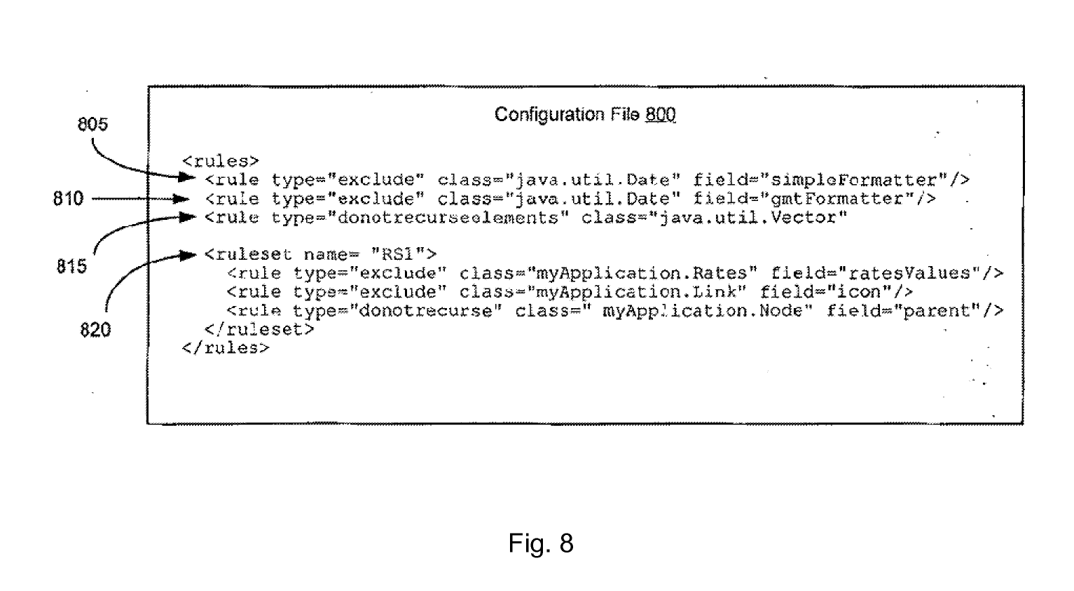

In an embodiment, configuration manager 130 provides STE 120 with rules that define, at least in part, the scan and transform process. Configuration manager 130 is further discussed below with reference to FIG. 8. Persistence manager 140 (and its Application Program Interface (API) 142) receives the intermediate data structure from STE 120 and writes it to a persistent media such as database 144, file system 146, and the like. Different Persistence Managers may be implemented for different persistent media. Persistence manager 140 is further discussed below with reference to FIGS. 7-8. In an embodiment, cache 150 holds a subset of the objects persisted by system 100 to improve the performance of the system.

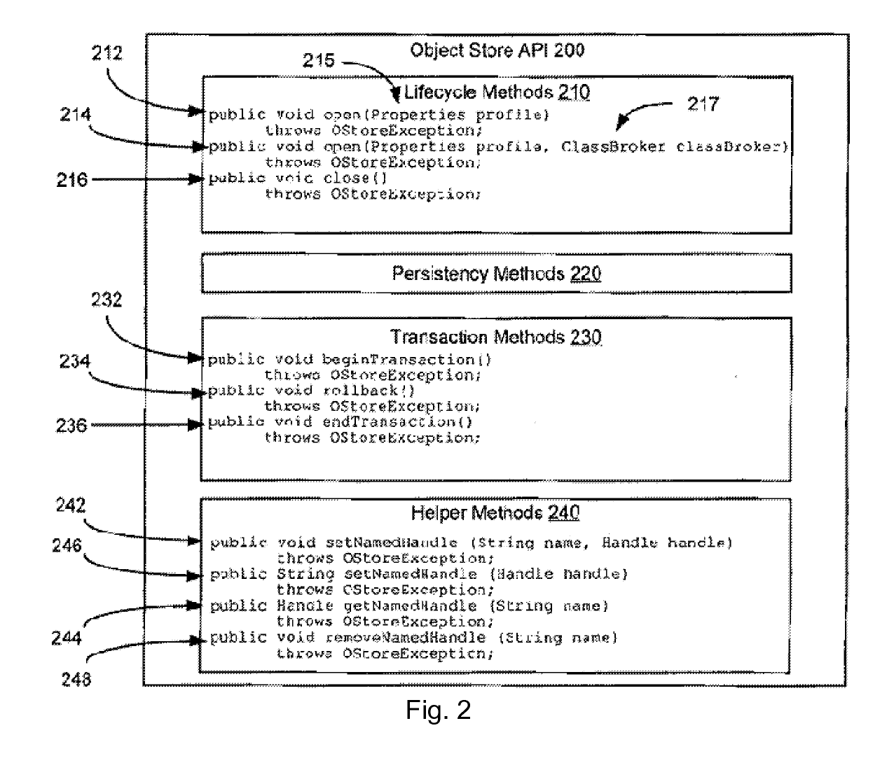

Object store API 122 provides the interface between application 110 and STE 120. FIG. 2 is a block diagram illustrating the structure of object store API 200 according to an embodiment in accordance with the present disclosure. Object store API 200 includes lifecycle methods 210, persistency methods 220, transaction methods 230, and helper methods 240. In an alternative embodiment, object store API 200 may be structured to include more sets of methods, fewer sets of methods, and/or different sets of methods.

Lifecycle methods 210 initiate and end access to a persistence system (e.g., persistence system 100, shown in FIG. 1). The illustrated embodiment of lifecycle methods 210 includes open methods 212 and 214 as well as close method 216. Open methods 212 and 214 open persistence system 100 prior to use. Open methods 212 and 214 take profile object 215 as a parameter. Profile object 215 includes profile information for persistence system 100 such as a PersistenceManager class, a data store identifier, a configuration file, a username, and a password.

The PersistenceManager class is the fully qualified class name of the persistence manager that is used (e.g. persistence manager 140, shown in FIG. 1). A class typically has both a simple name and a fully qualified name. The simple name is the name given to the class in its definition. A “fully qualified” name also includes the name of the package of which the class is a part.

The data store identifier specifies which data store to use (e.g., database 144 and file system 146). The value of this property may depend on the persistence manager defined with the PersistenceManager class. For example, for a Java Database Connectivity (JDBC) persistence manager, the value of this property is a JDBC string pointing to a database (e.g., database 144). For a file based persistence manager this could be a file name or the fully qualified name of a directory.

The “configuration file” refers to a name (e.g., the fully qualified name) of a configuration file containing one or more rules for defining the behavior of, for example, STE 120. Referring again to FIG. 1, configuration manager 130 uses this information to access and read the configuration file (e.g., configuration file 132). In one embodiment, configuration file 132 is an XML formatted file stored in a file system. In an alternative embodiment, configuration manager 130 utilizes different media to store the configuration (e.g., “configuration store”). The rules defined in configuration file 132 define, in part, the scan and transform process of STE 120. Configuration file 132 is further discussed below with reference to FIG. 8.

Open method 214 is directed to applications that implement their own class loading. Persistence system 100 creates instances of application classes when retrieving persistently stored information. To create instances of application classes, persistence system 100 accesses the classes of the objects to be instantiated. The second parameter of open method 214 (e.g., classBroker parameter 217) enables persistence system 100 to have access to classes loaded by the application class loaders. In one embodiment, a class with a method Class classForName (className) uses the application class loaders to find the required classes.

Close method 216 closes persistence system 100. Closing persistence system 100 assures that clean-up operations, such as closing opened files or data bases, are properly executed to avoid data loss. Closing persistence system 100 also assures that system resources (e.g., memory, etc.) are returned to the system.

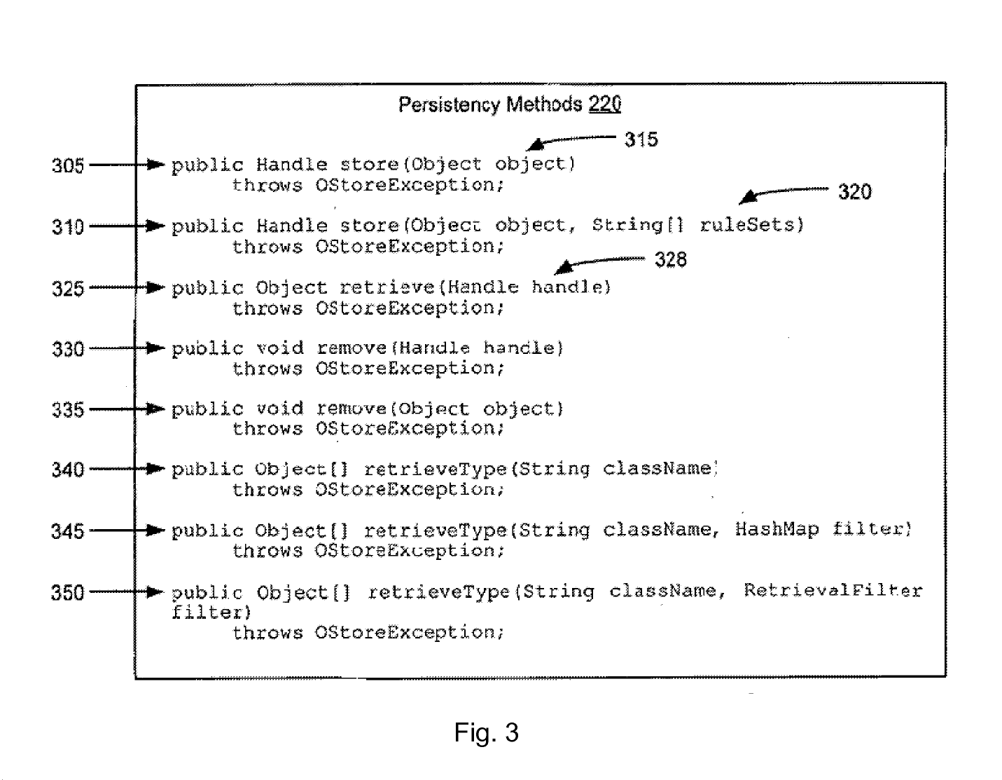

Persistency methods 220 provide access to objects stored in persistence system 100. FIG. 3 is an illustration of persistency methods 220 according to an embodiment in accordance with the present disclosure. In an embodiment, store methods 305 and 310 persist data in persistence system 100. Store methods 305 and 310 first determine whether data (e.g., object 315) is already stored. If the object is already stored in persistence system 100, then the object is updated. If the object does not yet exist in the system, it is inserted. For both update and insert operations the whole object closure defined by the object is persisted. In other words, not only the object itself, but also all referenced objects are recursively stored (or updated) in the system. In either case, the handle for the stored object, that is the object closure's anchor object, is returned.

A handle object is an instance of a class that implements Handle. Handle instances are created by persistence system 100 rather than the application (e.g., application 110, shown in FIG. 1). The application uses the handles to retrieve stored objects. Nonetheless, handles themselves can be persisted explicitly, for example, for bootstrapping purposes. Such handles are called “named handles.” An application can create named handles using special OStore methods to store a handle under a name. The application can choose the name by itself. If the application, for example, uses a hard-coded string it can read the named handle back from OStore the next time the application runs. Based on the named handle, the application can then read its data from OStore.

An application can store and retrieve handles in persistence system 100 using names (e.g., based on java.lang.String). Thus, named handles serve as externally accessible “starting points” for object closures, and are useful for initial object retrieval from persistence system 100. For example, an application could use the class name of the application main class for a named handle, to retrieve an initial object closure. Then, the application can use handles stored within the initial object closure to access further objects in persistence system 100 and other named handles to access further closures.

Store method 310 is substantially similar to store method 305 but it also includes ruleSets parameter 320. RuleSets parameter 320 provides zero or more rule sets to define, at least in part, the behavior of STE 120. More precisely, RuleSets parameter 320 provides the name(s) of the rule stets. The rules/rule sets are defined in the rules/configuration file (e.g., configuration file 132, shown in FIG. 1). These rule sets may augment or override default rules that are provided by, for example, a configuration file (e.g., configuration file 132, shown in FIG. 1).

Retrieve method 325 is used to retrieve an object from persistence system 100. In an embodiment, the caller identifies an object closure to retrieve with a handle (e.g., handle 328). This handle is returned by store methods 305 and 310 during the store operation. In an alternative embodiment the retrieve method 325 could have an additional parameter ruleSet. This ruleSet is identical to the rule set of store method 310. The benefit of a rule set during a retrieve operation is to reduce the amount of data that has to be read from the data base. If, for example, for the retriever of an object closure only one member of the anchor object is of interest, a rule set can help to reduce the load on the data base: The rule set can prevent the embodiment from retrieving the whole object closure by excluding all members of the anchor object that refer to other objects. Such an alternative embodiment, however, cannot cache object closures retrieved with a rule set in the same way as object closures retrieved without a rule set: A later caller to retrieve is not aware of how the object closure was retrieved, and that it may be incomplete due to a rule set. Such, the cached object closure cannot be returned. There are at least two ways to handle objects retrieved with rule sets: a) do not cache them at all or b) cache them with the rule set that was used to retrieve them. In the latter case the cached object closure may only be returned in case the rule set used during the first retrieve operation is a subset of the rule set used during later retrieve operations.

Remove methods 330 and 335 remove objects from persistence system 100. Remove method 330 identifies the object to be removed by passing its handle. Remove method 335 identifies the object to be removed by passing the object itself. Unlike store methods 305 and 310, remove method 335 is not recursively invoked on referenced objects. That is, only the object itself and not the object closure is removed from persistence system 100. Removing an object from persistence system 100 may render objects of the object closure unreachable. Thus, persistence system 100 periodically triggers a mechanism similar to the Java garbage collection mechanism to remove unreachable objects. The actual cleanup mechanism is implemented by the persistence manager (e.g., persistence manager 140, shown in FIG. 1). This mechanism can either be triggered periodically, or on demand, for example each time after the stored data is changed. In an alternative embodiment remove methods 330 and 335 could come with modified semantics and an additional parameter ruleSet: In the alternative embodiment the remove methods would remove the whole object closure, while the rule set would limit the scope of the remove operation in analogy to the rules for store and retrieve.

RetrieveType methods 340-350 enable a caller to retrieve a set of object closures with common features through one operation. RetrieveType method 340 retrieves all object closures of a specified class. The fully qualified class name is provided as a parameter for RetrieveType method 340.

RetrieveType method 345 is similar to RetrieveType method 340 but it reduces the result set by applying a filter. The filter works on a very low level without restoring the actual objects. The entries in the filter data structure (e.g., HashMap) are name/value pairs. The name of an entry is a string denoting a member of the class. It has the format <fully qualified class name>.<member name>. The fully qualified class name is used to discriminate members in the inheritance hierarchy, for example, when members are overwritten in a subclass. The value of an entry is either a String, or, for primitive types, an instance of the respective boxing class. RetrieveType method 345 returns those object closures that match the values in the filter data structure (e.g., HashMap).

RetrieveType method 350 is similar to RetrieveType method 345 but it employs a filter that is more powerful and less efficient. All instances of the class are retrieved as object closures from persistence system 100. The retrieved objects are then passed to the filter. The filter (e.g., a filter object) implements a method called accept( ) which can perform arbitrary computations on the object closures, and eventually returns a Boolean value. If the result for an object closure is true, then the object closure is added to the result, otherwise, it is ignored. In an alternative embodiment retrieveType methods could have an additional parameter ruleSet. In analogy to the retrieve method, the rule set could be used to restrict the scope of the retrieve operation with the benefit of less load on the data base.

Referring again to FIG. 2, transaction methods 230 are used to begin, end, and cancel transactions. Begin transaction method 232, begins a transaction. Rollback method 234 undoes the effect of all store and remove operations executed since the last begin transaction call. End transaction method 236 is called to actually persist (e.g., commit) the effects of all store and remove operations executed since the last begin transaction call. In an embodiment, each begin transaction operation is matched by either an end transaction operation or a rollback operation (in an embodiment, application 110, shown in FIG. 1, satisfies this constraint).

In an embodiment, helper methods 240 store and retrieve named handles. SetNamedHandle method 242 stores a handle that is identified by its name. Similarly, getNamedHandle method 244 retrieves a handle that is identified by its name. Method 246 is similar to method 242 except that it creates a unique name which is returned. Method 248 removes a named handle.

Referring again to FIG. 1, STE 120 examines and converts an object (e.g., a Java object) to an intermediate representation. The intermediate representation of the object is then passed to persistence manager 140. The object examination process uses introspection (e.g., Java introspection). In one embodiment, the Java Reflection API is used to implement the examination. Since persistency is based on introspection, no preconditions or requirements, like implementing certain interfaces (e.g., java.io.Serializable), inheriting from certain classes, or providing metadata (e.g., table or field definitions), are imposed on the objects.

In an embodiment, the intermediate representation of an object is a data structure, with one entry per member of the object. Each entry includes a name/value pair. In one embodiment, the name of each entry is a string consisting of the member's fully qualified class name and the member's name, separated by a dot (‘.’). Note that the member's class name is not necessarily the object's class. For members in which the object's class inherits from a superclass, the superclass's name is used. For example, consider two classes A and B. A defines a member a, and B inherits from A, and defines an additional member b. For an instance i of B, the name for b is B.b, while the name for a is A.a.

In one embodiment, the value of each entry is one of: the boxing class of a primitive type, a string, or a handle. The term “boxing” refers to converting a primitive type to a reference type. In one embodiment, strings are represented by the java.lang.String class. As is further described below, handles may be used when a member is itself composed of sub-members (e.g., when the member is an array).

### Storing Objects

Three examples of scanning and transforming objects are discussed below. The first approach introduces a less complex example of an embodiment in accordance with the present disclosure. The second approach introduces specific handling to improve performance (note that this is optional). The third approach refines the second by introducing rules to control what is stored and how it is stored. Note that numbers in brackets like “(n)” or “(n-m)” refer to code line n or lines n-m in the listings below. It is to be appreciated that the code listings that appear below are pseudo code (e.g., they resemble JAVA but are not “real” JAVA).

The first approach, as illustrated in Listing 1, shows the basic principle: All objects ultimately can be broken into arrays and primitive typed values like integer values (int), long values (long), floating point values (float), etc. When an object is stored (1) a distinction is made between arrays (2-3) and other kinds of objects (4-5).

When an object (which is not an array) is stored (8-19) all of the object's members are scanned, transformed, and stored. For each member (belonging to the object's class and its super classes) a dataset is created and collected in an intermediate data structure. The data structure is handed over to the persistence manager (17). There it is stored.

In an embodiment, a so-called class “Member” is used to collect a member's dataset: its name, value, type and the declaring class. The name is a string, the value is an object, the type and the declaring class are Java classes. The scan and transformation process guarantees that the value is only one of the following things: a string, an instance of a boxing class (Integer, Long, Float . . . ) or an instance of Handle. The type corresponds to the value: String.class, Integer.class, Long.class . . . Handle.class. The declaring class is necessary for the following reason: An object's member may not necessarily have been declared in the object's class itself. It may also have been declared in one of the object's superclasses. Consider two classes A and B. A declares a member a, and B inherits from A, and defines an additional member b. For an instance i of B, the declaring class of b is B while the declaring class for a (which is also present in i) is the declaring class in A.

In an embodiment, the intermediate data structure is an array of instances of Member. An object's member m can be both, of primitive type (an int, long, float . . . ) or any kind of object. If m is of primitive type, an instance of Member is created and added to the intermediate data structure (13). Note that the primitive typed member is stored as an instance of its corresponding boxing type, for example int 42 is stored as Integer(42); nevertheless the primitive type's class is stored (“int” not “Integer”) as type. The declaring class is the class declaring m (the object's class or one of int superclasses). If m is a kind of object then the algorithm is recursively called again (15) which ultimately results in a handle. The handle is stored instead of the object's value in a further instance of Member. This instance is added to the intermediate data structure, too (15). After all members of the object have been scanned and transformed, the intermediate data structure is handed over to the persistence manager where it is stored (17). Finally the object's handle h is returned to the caller (18). Note that handle h is not a result of storing the intermediate data structure; it is delivered by the persistence manger in a separate call (10). This is necessary for the following (simple) reason: If an object references itself (directly or indirectly) its handle must be known before storing its intermediate data structure, simply because the intermediate data structure contains the handle in one of the covered Member instances.

Storing an array (21-32) in fact resembles the handling of an object (8-19), but with one important difference: An array does not have members like an object has, it has indexed elements. The scan and transformation process walks through all elements of an array and treats them in the same way it treats the members of an object: If element e is of primitive type it creates an instance of Member and adds it to an intermediate data structure (26), or if element e is a kind of object it (recursively) calls our algorithm again (28) and stores the resulting handle instead of the object's value in a further instance of Member. Note that, in the case of arrays, the array's class is taken as a member's declaring class (26) (28). The instance of Member is also stored in the intermediate data structure. Similar to the case of objects, the intermediate data structure is handed over to the persistence manager where it is stored (30). Finally the array's handle h is returned to the caller (31). Note that in the case of arrays instead of member names, which do not exist, an element's index is used as member name (26) (28).

LISTING 1

```
  1 Handle store(Object o) {
  2 if o isArray
  3 return storeArray(o)
  4 else
  5 return storeObject(o)
  6 }
  7
  8 Handle storeObject(Object o) {
  9 IntermediateDataStruture i = new IntermediateDataStruture( )
10 Handle h = persistenceManager.createHandle(o.class)
11 for all members m of o (of the object's class and its super
classes) {
12 if m is of primitiveType
13 i.add(new Member(m.name, m (boxed),
primitiveType.class, declaringClass)
14 else
15 i.add(new Member(m.name, store(m), Handle.Class,
declaringClass)
16 }
17 persistenceManager.insert(h,i)
18 return h
19 }
20
21 Handle storeArray(Array a) {
22 IntermediateDataStruture i = new IntermediateDataStruture( )
23 Handle h = persistenceManager.createHandle(a.class)
24 for all elements e of a {
25 if e is of primitiveType
26 i.add(new Member(toString(IndexOf(e)), e(being
boxed), primitiveType.class, a.class)
27 else
28 i.add(new Member(toString(IndexOf(e)), store(e),
Handle.class, a.class)
29 }
30 persistenceManager.insert(h,i)
31 return h
32 }
END LISTING 1
```

The second approach adds to the first approach a specific handling for strings (see, e.g., code lines 34-35 and 68-74 below). This is done for performance reasons: Instead of storing a string ultimately as an array of characters (with probably hundreds of single character elements) strings are treated as strings. As all major data bases today have a native notion of strings, we assume that every persistence manager implementation also has a native notion of strings.

In an embodiment, when an object is stored (33) a distinction is made between strings (34-35), arrays (36-37), and other kinds of objects (38-39). Storing a string is handled as follows (68-74): The string is treated as a single-member object. The member is given the name “value”. The member's value is the string. The member's class and declaring class is String.class (71). An instance of Member is created and added to an intermediate data structure. The intermediate data structure is handed over to the persistence manager where it is stored (72). Finally, the string's handle h is returned to the caller (73). Storing arrays and other kinds of objects is described above with reference to the first approach. Listing 2 illustrates selected aspects of the second approach.

LISTING 2

33 Handle store(Object o) {
34 if o isInstanceOf String
35 return storeString(o)
36 if o isArray
37 return storeArray(o)
38 else
39 return storeObject(o)
40 }
41
42 Handle storeObject(Object o) {
43 IntermediateDataStruture i = new IntermediateDataStruture( )
44 Handle h = persistenceManager.createHandle(o.class)
45 for all members m of o (of the object's class and its super
classes) {
46 if m is of primitiveType
47 i.add(new Member(m.name, m (being boxed),
primitiveType.class, declaringClass)
48 else
49 i.add(new Member(m.name, store(m), Handle.class,
declaringClass)
50 }
51 persistenceManager.insert(h,i)
52 return h
53 }
54
55 Handle storeArray(Array a) {
56 IntermediateDataStruture i = new IntermediateDataStruture( )
57 Handle h = persistenceManager.createHandle(a.class)
58 for all elements e of a {
59 if e is of primitiveType
60 i.add(new Member(toString(IndexOf(e)), e (boxed),
primitiveType.class, a.class)
61 else
62 i.add(new Member(toString(IndexOf(e)), store(e),
Handle.class, a.class)
63 }
64 persistenceManager.insert(h,i)
65 return h
66 }
67
68 Handle storeString(String s) {
69 IntermediateDataStruture i = new IntermediateDataStruture( )
70 Handle h = persistenceManager.createHandle(String.class)
71 i.add(new Member(“value”, s, String.class, String.class)
72 persistenceManager.insert(h,i)
73 return h
74 }
END LISTING 2

The third approach extends the second (and the first) approach by introducing rules to control which and how things are stored (see, e.g., the italic parts of the code lines 75-126 below). The rules introduced in the third approach control whether a member is stored or not, whether the algorithm is applied recursively to a member object or not, and whether the elements of a container (like arrays, lists, sets, vectors . . . ) are excluded from the algorithm.

It is possible to declare that a certain object's member (of primitive type or any kind of object) is to be excluded from being stored (92-93). This is done using OStore's rule file. As a result the member will not be stored and, as a consequence, will be defaulted to a member type specific default when retrieved from the database. An application for this kind of rule is to prevent irrelevant fields from being stored. One example is cached values that are computed and held redundantly. Other examples are class constants. They need not to be stored.

It is possible to declare that a certain object's member shall not be scanned recursively by our algorithm (97-98). (This rule is only applicable for members that are objects, not for primitive type members.) This is done using OStore's rule file. Instead the object's handle is taken from the cache (97). To keep the object store consistent, however, in an embodiment it is mandatory that a member has been scanned recursively and stored earlier, before it can be excluded. The reason is because then the object is cached and its handle can be retrieved from the cache. It is an error if the object is not in the cache. As introduced in the first approach the handle is stored instead of the object's value (98). Excluding a specific member from being recursively scanned is desirable, for example, when within a tree structure each object not only points to its children but also to its parent. If such a tree's top object is stored, the complete tree is scanned following the children references and scanning back along the parent references is redundant. Excluding the parent link via a rule prevents the STM 120 from doing so.

It is possible to declare that a certain container's elements are not scanned recursively by the algorithm (99-102). This is done using OStore's rule file. Containers are objects like lists, sets, maps, vectors . . . and arrays. Ultimately all of the mentioned objects types store their elements within arrays. To exclude a container's elements from being scanned recursively the scan and transformation process is slightly modified by switching to the “doNotRecurseElements” mode. Therefore the doNotRecurseElements flag is set to true (100). After the container has been handled the mode is switched back by setting the doNotRecurseElements flag to false (102). The doNotRecurseElements flag is part of the “Flags” class, a simple data structure to cover boolean values (191-194). The structure is handed down recursively to the storeArray( )method. If the scan and transformation process is in mode “doNotRecurseElements” an array's element (which is not of primitive type) is not scanned but its handle is taken from the cache (119). The handle is stored instead of the object's value (119). To keep the object store consistent, however, in an embodiment it is mandatory that a member has been scanned recursively and stored earlier, before it can be excluded. The reason is because then the object is cached and its handle can be retrieved from the cache. It is an error if the object is not in the cache. One example for applying the exclusion rule is the update of a node in a tree. Assume a tree structure has been persisted in OStore. Each node holds a list of references to its children. Now one node in the tree is to be updated. If the member for the children list cannot be excluded from the scan and transformation process, the whole sub-tree below the node will be updated, too. Excluding the member from the scan and transformation process improves the efficiency of the store method. Listing 3 illustrates selected aspects of the third approach.

```
LISTING 3
  75 Handle store(Object o) {
  76 return store(o, new Flags( ))
  77 }
  78
  79 Handle store(Object o, Flags flags) {
  80 if o isInstanceOf String
  81 return storeString(o, flags)
  82 else if o isArray
  83 return storeArray(o, flags)
  84 else
  85 return storeObject(o, flags)
  86 }
  87
  88 Handle storeObject(Object o, Flags flags) {
  89 IntermediateDataStruture i = new IntermediateDataStruture( )
  90 Handle h = persistenceManager.createHandle(o.class)
  91 for all members m of o (of the object's class and its super
classes) {
  92 if ruleManager.exclude(m)
  93 continue with next member
  94 else if m is of primitiveType
  95 i.add(new Member(m.name, m(being boxed),
primitiveType.class, declaring class)
  96 else {
  97 if ruleManager.doNotRecurse(m)
  98 i.add(new Member(m.name, cache.get(m),
Handle.class, declaringClass)
  99 else if ruleManager.doNotRecurseElements(m)
100 flags.doNotRecurseElements = true
101 I.add(new Member(m.name, store(m, flags),
Handle.class, declaringClass)
102 flags.doNotRecurseElements = false
103 else
104 i.add(new Member(m.name, store(m, flags),
Handle.class, declaringClass)
105 }
106 }
107 persistenceManager.insert(h,i)
108 return h
109 }
110
111 Handle storeArray(Array a, Flags flags) {
112 IntermediateDataStruture i = new IntermediateDataStruture( )
113 Handle h = persistenceManager.createHandle(a.class)
114 for all elements e of a {
115 if e is of primitiveType
116 i.add(new Member(toString(IndexOf(e)), e(boxed),
primitiveType.class, a.class))
117 else {
118 if flags.doNotRecurseElements == true
119 i.add(new Member(toString(IndexOf(e)),
cache.get(e), Handle.class, a.class))
120 else
121 i.add(new Member(toString(IndexOf(e)), store(e,
flags), Handle.class, a.class))
122 }
123 }
124 persistenceManager.insert(h,i)
125 return h
126 }
127
128 Handle storeString(String s) {
129 IntermediateDataStruture i = new IntermediateDataStruture( )
130 Handle h = persistenceManager.createHandle(String.class)
131 i.add(new Member(“value”, s, String.class, String.class)
132 persistenceManager.insert(h,i)
133 return h
134 }
END LISTING 3
```

FIG. 4 illustrates the process of generating an intermediate data structure, according to an embodiment in accordance with the present disclosure. STE 120 identifies the elements of object 400 using introspection. In one embodiment, object 400 is a Java object and the Java Reflection API provides the introspection mechanism. Object 400 includes elements 402-412.

Java objects consist of members having one of the following member types: primitive types (int, long, double . . . ) or objects such as strings, arrays or other kinds of objects.

STE 120 processes each member based, at least in part, on its member type. Table 1 provides processing rules for Java member types according to an embodiment in accordance with the present disclosure. In an alternative embodiment, STE 120 may apply more rules, fewer rules, and/or different rules.

TABLE 1

| Member Type | Processing Rule |
|---|---|
| Has a primitive type | Create an instance of the member's |
| (byte, char, short, | boxing class with the member's value, |
| int, long, float, | and store it in the intermediate data |
| double, or boolean) | structure. |
| Is of type String | Store the member as it is in the |
| (e.g., java.lang.String) | intermediate data structure. |
| Is a reference to an object | Scan and transform the referenced |
| of type Array | array by looping over all array |
| | elements, and recursively apply the |
| | algorithm to the array elements. |
| | Storing the transformed array returns |
| | a handle which in turn is stored in |
| | the intermediate data structure as a |
| | placeholder for the referenced array. |
| Is a reference to another | Recursively apply this algorithm to |
| object | scan and transform the referenced |
| | object. Storing the transformed object |
| | returns a handle which in turn is |
| | stored in the intermediate data |
| | structure as a placeholder for the |
| | referenced object. Cyclic references |
| | are detected and addressed. In an |
| | embodiment, this rule applies to |
| | both instances of a built-in Java |
| | class and a user defined class. |

END TABLE 1

The rules shown above are sufficient to transform even complex object closures because all members of Java objects ultimately consist of primitive types and arrays. While strings might also be handled as character arrays, experience shows that the rule for strings shown above improves performance. This procedure is valid, because even the most primitive persistence managers have a native notion of strings.

Referring again to FIG. 4, table 420 illustrates an intermediate data structure corresponding to object 400. The entries in table 420 correspond to instances of class Member (see the discussion above with reference to listings 1-3). For each member of object 400 (402-412) a corresponding instance of class Member is created (422-432). Each instance covers an object member's name (Name column), a representation of its value (Value column), a type (Type column) and the declaring class (DeclaringClass column). Object members of primitive type (402, 404) are stored as objects of their corresponding boxing class (422, 424). The stored type is the original primitive type. Object members of any type of object (406-412) are transformed by the algorithm into further intermediate data structures (as illustrated by tables 440, 450, and 460) which are stored by the persistence manager, finally resulting in handles (e.g., handle h1, h2, h3). Handles are stored instead of the object (426-432). The stored type is Handle. Note the special case of a self-reference: Via member “self” (412) object 400 references itself. Consequently the intermediate data structure of object 400 covers an instance of class Member storing the corresponding handle h0 of object 400 (432).

### Updating Objects

Updating objects works in substantially the same way as storing them for the first time. The main difference, with respect to the algorithm, is that instead of creating a new handle for objects that are going to be stored, the object's handle is read from the cache. All objects already having been stored or having been read from the database (which means that they also already have been stored some time ago) are available in the cache as long as the application is accessing them. So instead of asking the persistence manager for a new handle (10) (23) (44) (57) (70) (90) (113) (129), OStore asks the cache for the handle. Finally instead of calling persistenceManager.insert(h,i) (17) (30) (51) (64) (72) (107) (124) (132) OStore calls persistenceManager.update(h,i).

### Retrieving Objects

When an object is retrieved the cache is checked at first (See, e.g., code line 136, show in listing 4) whether the object is already available or not. If yes, it simply can be returned. If not, at first the object's class is determined. The persistence manager (and only the persistence manager) is able to interpret a handle and to return the class of the object that corresponds to the handle (139). Dependent on the class a string (140-141), an array (142-143) or an object of another type (144-145) is retrieved.

To retrieve a string (148-152) its intermediate data structure is first retrieved from the persistence manager (149). The intermediate data structure of a string only has a single element such as an instance of class Member. This instance's value member is taken to create a new string and to return it to the caller (151).

To retrieve an array (168-180) the array's class is first determined with the help of the persistence manager (169). After that the array's intermediate data structure is retrieved from the persistence manager (170). Then a new array with the required size is created (171). Now all instances of class Member, which are covered by the intermediate data structure, are evaluated (172-178): A Member instance's “name” member determines the related array's element index (173). A Member instance's “value” member determines the related array element's value (175). Note that if the value is a handle at first the corresponding object has to be retrieved. Therefore the retrieval process is called recursively (175), ultimately resulting in the object represented by the handle. The retrieved object is assigned to the array's element (175). If the value is not a handle, which means that originally the element's value was of primitive type, the Member instance's “value” member can be assigned directly. Note that because the Member class stores all primitive typed values wrapped by it's boxing class, it is necessary to convert a boxing class object to a primitive type value before the assignment. When all elements of the arrays have been restored it is returned to the caller (179).

To retrieve an object (which is not an array) the object's class is first determined with the help of the persistence manager (155). After that the object's intermediate data structure is retrieved from the persistence manager (156). Then a new object is created (157). Creating the object is further described below with reference to FIG. 5. Now all instances of class Member, covered by the intermediate data structure, are evaluated (158-164). This process works in substantially the same way as in the case of an array (described above). The difference is that the final assignment is done to an object's members instead of an array's elements (161) (163). Listing 4 illustrates selected aspects of retrieving an object according to an embodiment in accordance with the present disclosure.

LISTING 4

135 Object retrieve(Handle h) {
136 Object object = cache.get(handle);
137 if object != null
138 return object
139 Class class = persistenceManager.getClass(h)
140 if class is String
141 return retrieveString(h)
142 else if class is an array class
143 return retrieveArray(h)
144 else
145 return retrieveObject(h)
146 }
147
148 Object retrieveString(Handle h) {
149 IntermediateDataStruture i = persistenceManager.select(h)
150 for the only element e of i
151 return new String(e.getValue)
152 }
153
154 Object retrieveObject(Handle h) {
155 Class c = persistenceManager.getClass(h)
156 IntermediateDataStruture i = persistenceManager.select(h)
157 Object o = newInstance(c)
158 for all elements e of i {
159 Field f = getField(c, e.getName( ), e.getDeclaringClass)
160 if e.getValue( ) isInstanceOf Handle
161 f.set(o, retrieve(e.getValue( )))
162 else
163 f.set(o, e.getValue( ))
164 }
165 return o
166 }
167
168 Object retrieveArray(Handle h) {
169 Class c = persistenceManager.getClass(h)
170 IntermediateDataStruture i = persistenceManager.select(h)
171 Object o = Array.newInstance(c, number of elements of i)
172 for all elements e of i {
173 int index = valueOf(e.getName( ))
174 if e.getValue( ) isInstanceOf Handle
175 Array.set(o, index, retrieve(e.getValue( )))
176 else
177 Array.set(o, index, e.getValue( ));
178 }
179 return o
180 }
181 public class Member {
182 private String name;
183 private Class type;
184 private Object value;
185 private Class declaringClass;
186 public Member (String name, Object value, Class type, Class declaringClass) {
187 ...
188 }
189 ...
190 }
191 public class Flags {
192 public boolean doNotRecurseElements;
193 ...
194 }
END LISTING 4

FIG. 5 illustrates a simplified coding example for locating an appropriate constructor for instantiating the class created above in listing 4. An attempt to obtain a default constructor is shown at 528. If a default constructor is not located, a configuration file (e.g., configuration file 132, shown in FIG. 1) is checked to see whether a specific constructor has been selected for the class at 530. If there is no default constructor and no specific constructor is selected in the configuration file, then the first constructor that can be for found for the class (e.g., for class cls) is used at 532. An attempt to execute the constructor is made at 534. If an error occurs, then the class is not instantiated as shown by 536. Otherwise, the object is returned at 538.

Referring again to FIG. 1, persistence manager 140 receives the intermediate data structure from STE 120. Persistence manager 140 then writes the data to a data store (e.g., database 144 or file system 146). In contrast to the other elements of persistence system 100, persistence manager 140 works on an object basis. That is, rather than storing and retrieving entire object closures, persistence manager 140 operates on the intermediate data structure of one object at a time. Typically, there is a different implementation of persistence manager 140 for each type of data store. Persistence manager API 142, therefore, defines an interface that can be implemented in multiple ways.

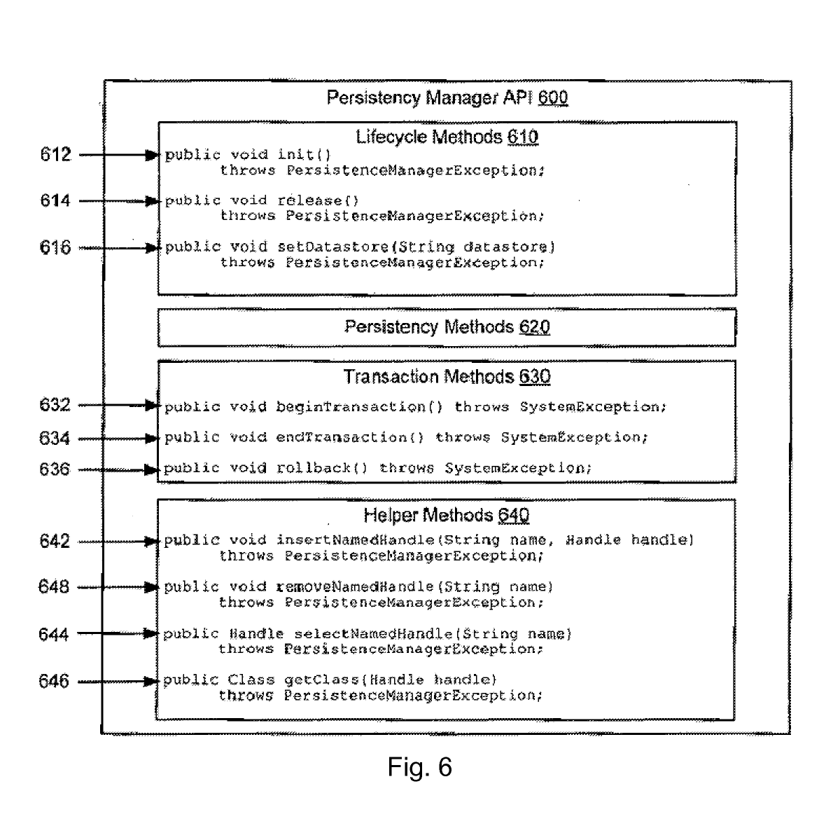

FIG. 6 is a block diagram illustrating the structure of persistence manager API 600 according to an embodiment in accordance with the present disclosure. The illustrated embodiment includes lifecycle methods 610, persistency methods 620, transaction methods 630, and helper methods 640. In an alternative embodiment, persistence manager API 600 may include more sets of methods, fewer sets of methods, and/or different sets of methods.

Lifecycle methods 610 include initiate method 612, release method 614, and setDatastore method 616. Initiate method 612 is used to initialize a persistence manager prior to using it. Release method 614 releases the persistence manager after it is used so that resources can be returned to the system and cleanup, as needed, can be implemented. SetDatastore method 616 is used to define the data store for the persistence manager. This is a persistence manager specific string denoting the location where the data is stored (e.g., a JDBC string pointing to a database or a qualified name of a directory).

FIG. 7 is a block diagram illustrating persistency methods 620. When an object is stored, STE 120 provides a data structure with all of the object's members to the persistence manager. Before the data structure is inserted, a corresponding handle is generated to identify the data structure. In an embodiment, createHandle method 710 creates the handle based on the parameter className. In one embodiment, createHandle method 710 returns a unique handle that can be used to identify the object inside the persistence manager. When an object is stored, the objects referenced by the stored object are stored handles. Thus, when an object directly or indirectly references itself, its handle is created before it is stored.

Insert method 720 inserts an object (or rather its corresponding data structure) into the persistence manager. In an embodiment, insert method 720 takes as a parameter a handle created by createHandle method 710 to identify the inserted object. Update method 730 is used to update objects that were previously stored. The object is identified by its handle, which was created when the object was inserted.

Delete method 740 deletes an object that is stored in a data store. The object is identified by its handle, which was created when the object was inserted. In an embodiment, only the object identified by the handle is removed. All other objects of the object closure remain unchanged. Select method 750 returns an object (or rather its corresponding data structure) stored in the data store. The object is identified by its handle, which was created when the object was inserted.

In an embodiment, selectHandles method 760 returns the handles of all objects of a certain class stored in the persistence manager. The set of matching objects can be reduced by specifying a filter. In one embodiment, the provided filter is an object of type HashMap. Filters are further discussed above with reference to FIG. 3.

Referring again to FIG. 6, transaction methods 630 are used to begin, end, and cancel transactions. Begin transaction method 632, begins a transaction. Rollback method 634 undoes the effect of all store and remove operations executed since the last begin transaction call. End transaction method 636 is called to actually persist (e.g., commit) the effects of all store and remove operations executed since the last begin transaction call. In an embodiment, each begin transaction operation is matched by either an end transaction operation or a rollback operation. This constraint is fulfilled by the application (e.g., application 110, show in FIG. 1).

In an embodiment, helper methods 640 store and retrieve named handles. For example insertNamedHandle method 642 stores a handle that is identified by its name. Similarly, selectNamedHandle method 644 retrieves a handle that is identified by its name.

Method 648 removes a named handle. In an embodiment, getClass method 646 returns the class (e.g., java.lang.Class) of the object identified by the provided handle. In an embodiment, only the persistence manager is able to interpret a handle.

Referring again to FIG. 1, configuration manager 130 provides a mechanism to control STE 120 in a rule based way. In an embodiment, the rules are, for example, defined in a configuration file 132. Configuration file 132 is, for example, an XML file. The path to the configuration file is handed over to persistence system 100 as one of its profile parameters when it is opened.

In an embodiment, the following rules are supported: excluding a specific member from being stored; excluding a specific member from being recursively scanned; and excluding the elements of a specific container from being scanned. In an alternative embodiment, more rules, fewer rules, and/or different rules are defined. Excluding a specific member from being stored is desirable, for example, when the member references runtime data that should not become part of the persistent store (e.g., cached data, rendered data, etc.). Excluding a specific member from being recursively scanned is desirable, for example, when within a tree structure each object not only points to its children but also to its parent. If such a tree's top object is stored, the complete tree is scanned following the children references and scanning back along the parent references is redundant. Excluding a container's elements from being scanned is desirable, for example, for VectorS because Vectors store references to their elements in an element array. Whenever a new element is added to a Vector, it is not necessary to update all elements of the Vector. Rather, it is sufficient to insert the new element and update the element array, which is already stored.

FIG. 8 illustrates a configuration file according to an embodiment in accordance with the present disclosure. Rules are either mandatory or optional. A mandatory rule is always applied to the members of an object. An optional rule is only applied if it is explicitly requested (e.g., by ruleSets parameter 320, shown in FIG. 3). In one embodiment, optional rules are organized as rules sets. In the illustrated embodiment of configuration file 800, rules 805-815 are mandatory rules. The rules shown in rule set 820, however, are optional rules.

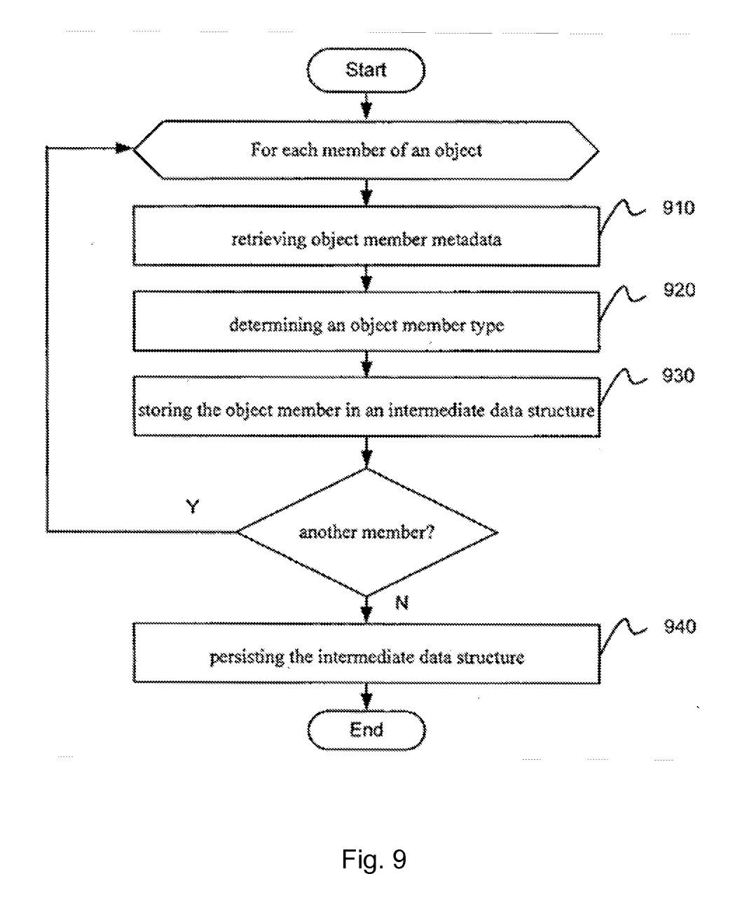

Turning now to FIG. 9, the particular methods associated with embodiments in accordance with the present disclosure are described in terms of computer software and hardware with reference to a flowchart. The methods to be performed by a computing device (e.g., an application server) may constitute state machines or computer programs made up of computer-executable instructions. The computer-executable instructions may be written in a computer programming language or may be embodied in firmware logic. If written in a programming language conforming to a recognized standard, such instructions can be executed on a variety of hardware platforms and for interface to a variety of operating systems. In addition, embodiments in accordance with the present disclosure are not described with reference to any particular programming language. It will be appreciated that a variety of programming languages may be used to implement embodiments in accordance with the present disclosure as described herein. Furthermore, it is common in the art to speak of software, in one form or another (e.g., program, procedure, process, application, etc.), as taking an action or causing a result. Such expressions are merely a shorthand way of saying that execution of the software by a computing device causes the device to perform an action or produce a result.

FIG. 9 is a flow diagram illustrating certain aspects of a method for persisting an object according to an embodiment in accordance with the present disclosure. A persistence system (e.g., persistence system 100, shown in FIG. 1) persists an object having one or more object members. In an embodiment, a Scan and Transform Engine (e.g., STE 120, shown in FIG. 1) scans and transforms each member of the object. Referring to process block 910, object introspection is used to retrieve object metadata. Object metadata includes, for example, object member names. Referring to process block 920, an object member type is determined based at least in part on the retrieved object member metadata. For example, the object member type may be used to distinguish whether the object member is a primitive type, array, or reference to another object.

Referring to process block 930, each object member is stored in an intermediate data structure based, at least in part, on its object member type. Table 1 illustrates an algorithm for storing object members according to an embodiment in accordance with the present disclosure. As discussed above with reference to FIG. 8, Mandatory and/or optional rules may also be used to determine whether and how to transform and store an object member.

Referring to process block 940, the intermediate data structure is persisted to a data store. The data store may be a database, a file system, and/or other store capable of providing non-volatile storage. In one embodiment, a persistence manager API provides an interface to one of several types of persistence managers. Each persistence manager is responsible for storing the information contained in the intermediate data structure onto a particular media.

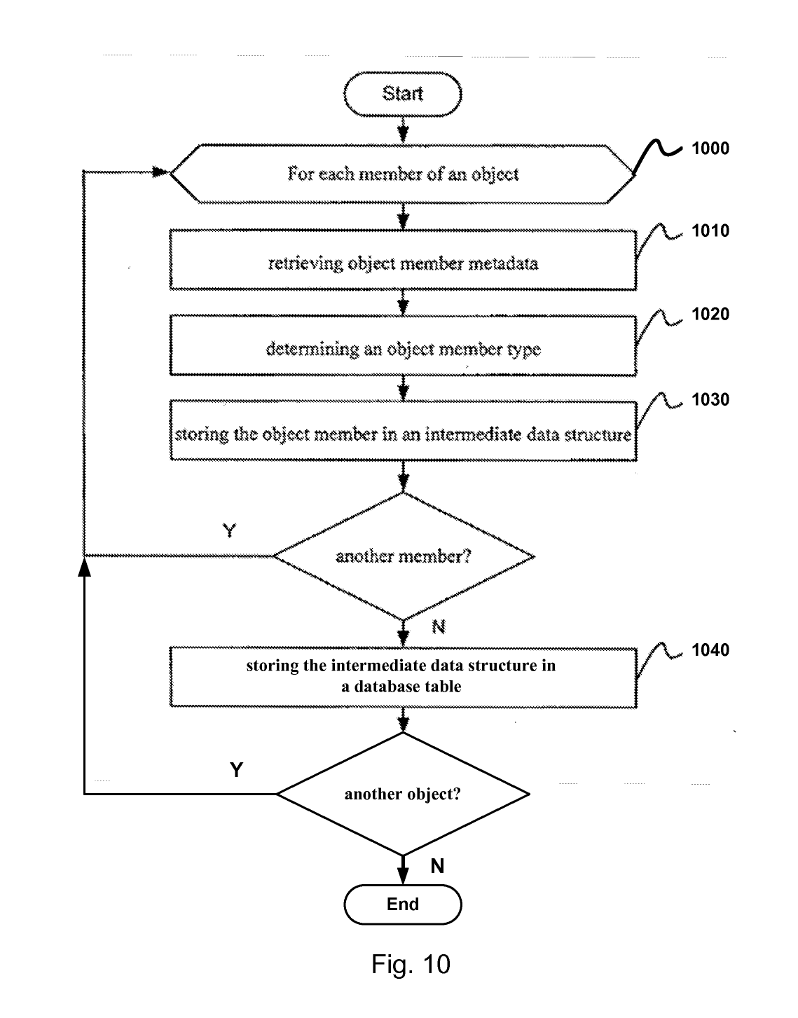

FIG. 10 is a flow diagram illustrating certain aspects of a method for persisting an object according to a particular embodiment in accordance with the present disclosure. The process blocks 1010-1030 are described above in connection with respective process blocks 910-930 in FIG. 9.

Referring to process block 1040, in a particular embodiment the intermediate data structure is persisted to a single data table file; e.g., a database table in a database. Details of the data table will be discussed below. Referring to process block 1050, if there is another object to be persisted, then the process may repeat by returning to processing block 1000 to process the next object.

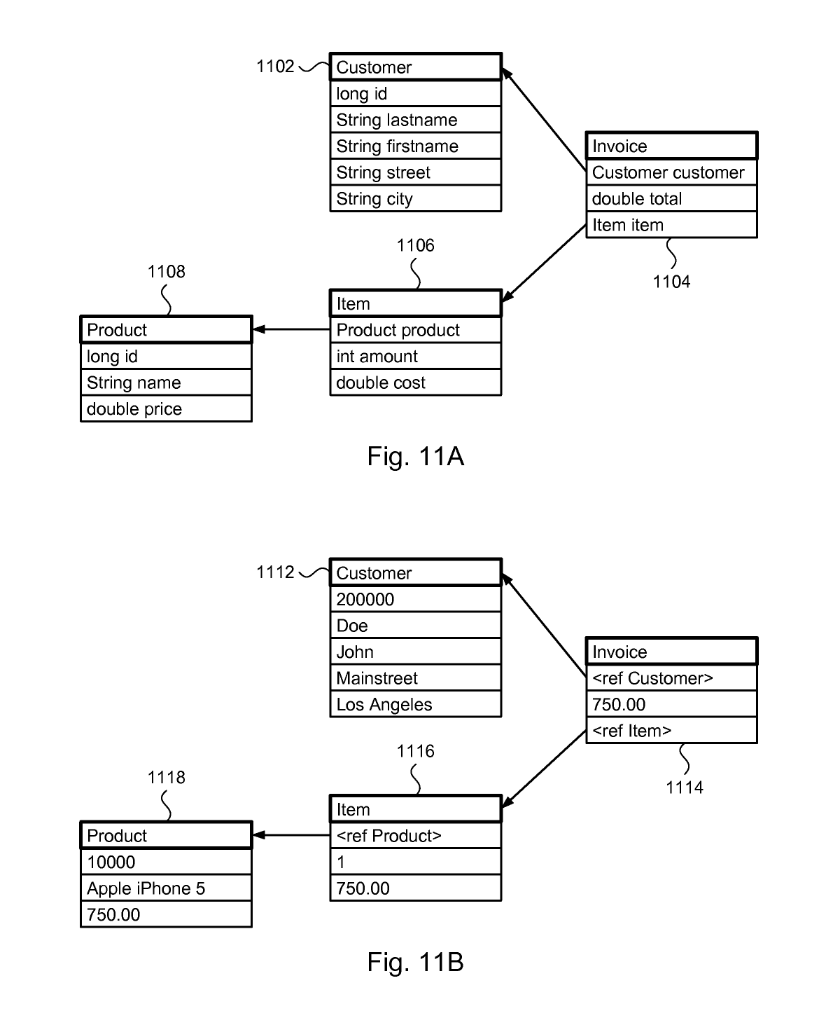

FIGS. 11A and 11B show an example of an object for illustrative purposes. FIG. 11A represents a class diagram (data model) of several classes of objects and relations among the objects. A Customer class 1102 comprises the following member: id, lastname, firstname, street, and city. An Invoice class 1104 has members: customer, total, and item. An Item class 1106 is defined by the following members: product, amount, and cost. A Product class 1108 includes id, name, and price, as its members. FIG. 11A, illustrates the relationships among the Customer, Invoice, Item, and Product classes 1102-1108.

FIG. 11B shows instances 1112-1118 of the classes 1102-1108 introduced in FIG. 11A, showing specific values for each member. For example, a Customer instance 1112 comprises an id member of “200000”, and lastname member of “Doe”, a firstname member of “John”, and street and city members of “Mainstreet” and “Los Angeles”. An Invoice instance 1114 includes members customer and item, which reference the Customer instance 1112 and an Item instance 1116. The Item instance 1116, in turn, includes a member called product, which references a Product instance 1118.

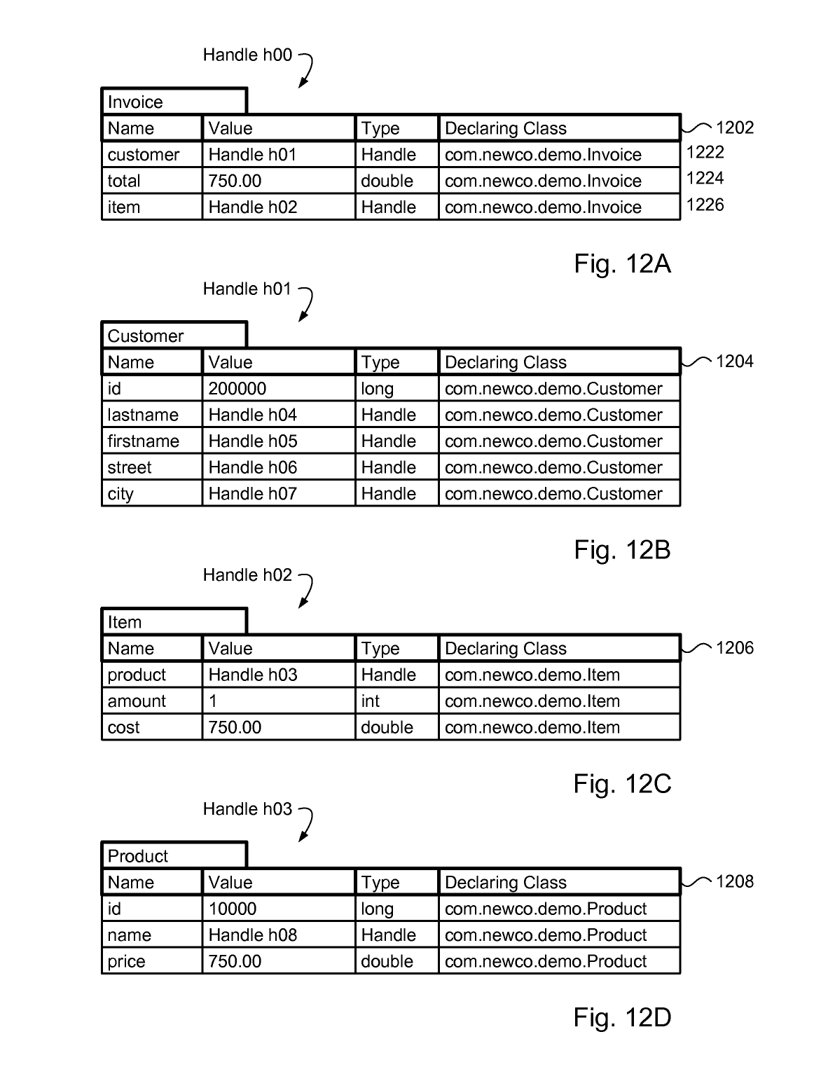

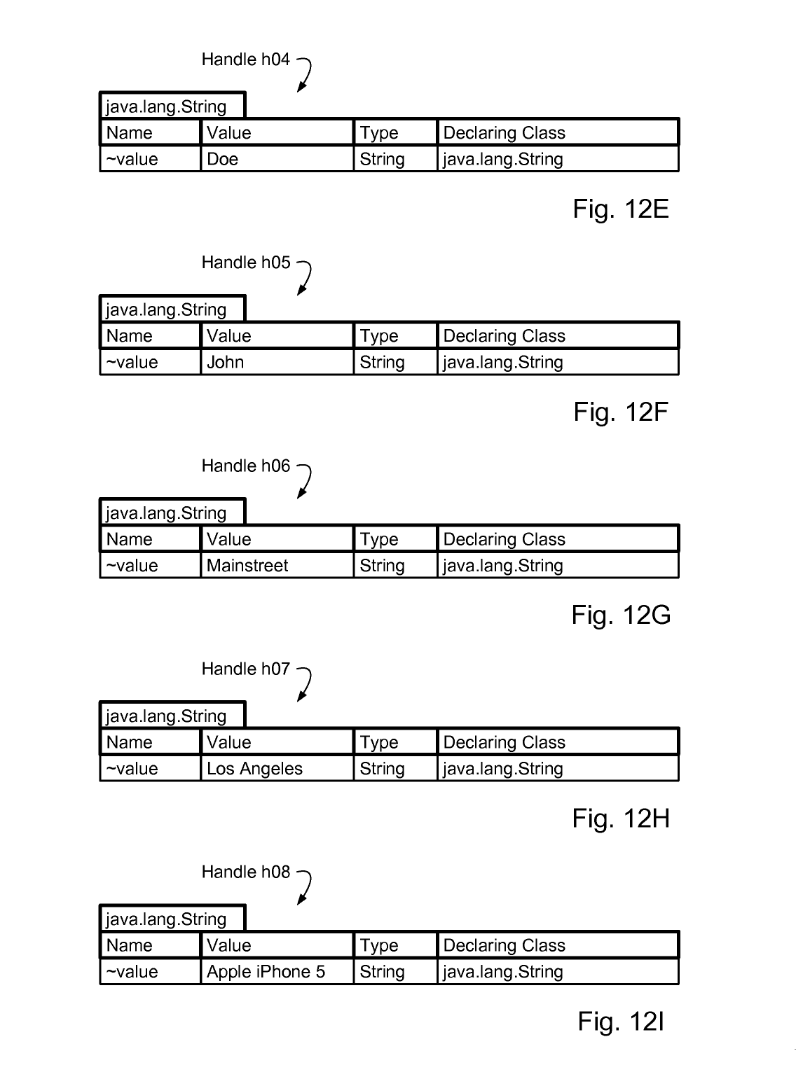

FIGS. 12A, 12B, 12C, and 12D illustrate examples of intermediate data structures 1202-1208 corresponding to the object instances 1112-1118 shown in FIG. 11B, in accordance with some embodiments. Consider FIG. 12A, for example. The intermediate data structure 1202 for the Invoice instance 1114 may be represented by a table. As explained in FIG. 4, the rows 1222, 1224, 1226 in table 1202 correspond to instances of class Member (see discussion above in connection with Listings 1-3), and will be referred to hereinafter as “member records”. A corresponding member record 1222, 1224, 1226 is created in the intermediate data structure 1202 for each member in the Invoice instance 1114. The member records 1222-1226 cover the object member's name, a representation of its value, a data type, and a declaring class. A member that is a reference to another object (for example 1222, 1226) is represented with type Handle and a value referencing an intermediate data structure that represents the object.

FIG. 12A, for example, illustrates an intermediate data structure 1202 that represents the Invoice instance 1114, and is accessed by handle “Handle h00”. Member records 1222 and 1226 are type Handle, and point to respective intermediate data structures 1204 (FIG. 12B) and 1206 (FIG. 12C). FIG. 12B, likewise, illustrates an intermediate data structure 1204 that represents the Customer instance 1112. FIGS. 12C and 12D similarly show intermediate data structures 1206 and 1208, which represent respective Item and Product instances 1116, 1118.

As mentioned above, instead of storing a string ultimately as an array of characters (with probably hundreds of single character elements) strings are treated as strings. As all major databases today have a native notion of “strings,” we can assume that every persistence manager implementation also has a native notion of strings. String instances may be stored as if they have one artificial member named “˜value” of type String to accommodate character strings of any length. Those instances are referred like other objects by handles in the intermediate data structure. Thus, for example, referring to FIG. 12B, the strings for the customer's last and first name and the address information may be stored in String objects and referenced by respective handles “Handle h04,” “Handle h05,” “Handle h06,” and “Handle h07.” FIGS. 12E-1I show intermediate structures for storing the strings that occur in FIG. 11B.

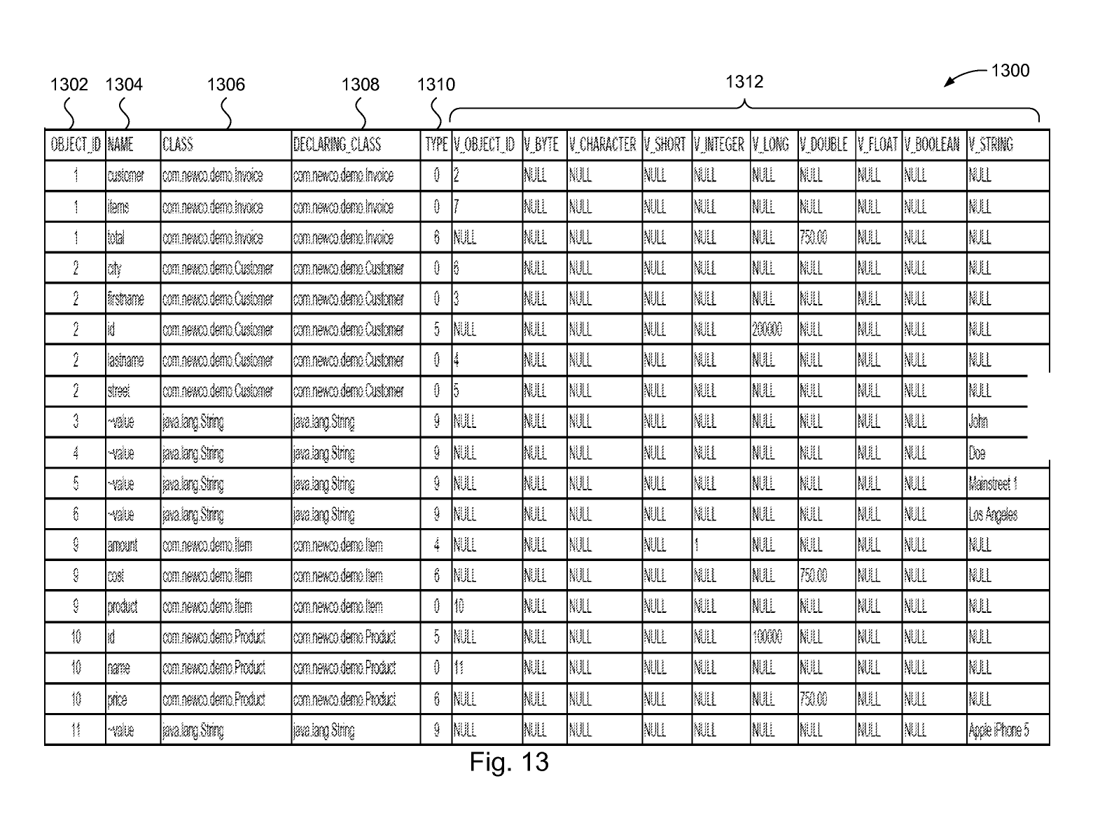

FIG. 13 illustrates an example of a data table 1300 in accordance with principles of the present disclosure for storing intermediate data structures (process block 1040, FIG. 10). In some embodiments, the data table 1300 may be a database table (e.g., in a relational database). For example, a database table called MEMBER may be defined by the following SQL CREATE TABLE statement:

LISTING 5

CREATE TABLE MEMBER (

| | |
|---|---|
| OBJECT_ID | BIGINT NOT NULL |
| NAME | LONGNVARCHAR NOT NULL |
| CLASS | LONGNVARCHAR NOT NULL |
| DECLARING_CLASS | LONGNVARCHAR NOT NULL |
| TYPE | SMALLINT |
| V_BYTE | SMALLINT |
| V_CHARACTER | NCHAR (1) |
| V_SHORT | SMALLINT |
| V_INTEGER | INTEGER |
| V_LONG | BIGINT |
| V_DOUBLE | FLOAT |
| V_FLOAT | REAL |
| V_BOOLEAN | BIT |
| V_STRING | LONGNVARCHAR |
| V_OBJECT_ID | BIGINT |

```
    CONSTRAINT MEMBER_PK PRIMARY KEY (OBJECT_ID,
    NAME, CLASS, DECLARING_CLASS)
    FOREIGN KEY (OBJECT_ID) REFERENCES OBJECT
    (OBJECT_ID)
)
END LISTING 5
```

Each row in the data table 1300 has the structure as defined in Listing 5. In accordance with the present disclosure, each member record (e.g., 1222, 1224, 1226, FIG. 12A) of each intermediate data structure (e.g., 1202, 1204, 1206) is stored in a corresponding row of the data table 1300. Consider for example, the Invoice instance 1114. The Invoice instance 1114 is represented by intermediate data structure 1202 in FIG. 12A. The data comprising member record 1222 is stored in the first row of data table 1300. The data comprising member record 1226 is stored in the second row of data table 1300, and so on.

All member records belonging to the same intermediate data structure are identified by a unique “object id” stored in a column 1302 of the data table 1300 called OBJECT_ID. As one intermediate data structure represents (the collection of all members of) one JAVA object instance (e.g., intermediate data structure 1202 in FIG. 12A represents the Invoice instance 1114), the object id also represents a stored JAVA object instance. Thus, for example, object id “1” in data table 1300 represents the Invoice instance 1114, and the member records 1222-1226 of intermediate data structure 1202 (representing the Invoice instance 1114) are identified in the data table 1300 by object id “1”. The object id “2” in data table 1300 represents the Customer instance 1112, and the member records of intermediate data structure 1204 have object id “2”, and so on. If a new instance of the Invoice object is instantiated and represented in a new intermediate data structure, a new object id would be assigned to represent the new instance in the data table 1300.

A member's name (of type String) is mapped to the data table's NAME column 1304 of type LONGNVARCHAR and stored in that column LONGNVARCHAR is used to allow national character strings of any length (the used data type at least has to allow strings of a member name's maximum length—according to JAVA's language specification). For example, the name of the Customer member in the Invoice instance 1114 is “customer”, and so “customer” is stored in the NAME column 1304 of the row that stores the member record 1222.

A member's type (of type class) is mapped to the data table's TYPE column 1310 of type SMALLINT and stored in that column. In some embodiments, we map an object's type to an integer number in the range of 1 . . . N to save disk space, where N is the number of data types defined by the particular language (e.g., JAVA) for representing the intermediate data store. Thus, for example, a data type Byte may be integer “1”, a data type Character may be integer “2”, a data type Short may be integer “3”, and so on. Integer “0” may be used to refer to the Handle type. In some embodiments, a handle is an instance of a JAVA class, which simply wraps an object id used to represent the records in table MEMBER belonging to the same intermediate data structure. In other embodiments, instead of representing data types using integers, the representation may be stored, for example, using a string that reflects the type's name; e.g., “Integer”, “Byte”, “Character”, and so on.

A member's declaring class (of type class) is mapped to the table's DECLARING_CLASS column 1308 of type LONGNVARCHAR and stored in that column. In some embodiments, we represent the declaring class be the class' name. Mapping a class to a number (as done for the instance's type) would be possible too, but would also mean to store a mapping table (number mapped to class) since the number of possible classes is potentially unlimited.

In order to rebuild an object instance based on the stored member records that represent the object instance's member, it is necessary to know the object instances' class. It is not enough to know the DECLARING_CLASS of a certain member which is used to handle object inheritance. Accordingly, we can store the object instances' class as a CLASS column 1306 in the data table 300. As explained with respect to the DECLARING_CLASS column 1308, we can use LONGNVARCHAR as data type. Another less redundant way of storing the object instance's class would be to add an additional record in the data table 1300 (same object id) that represents an artificial member of the related object instance (member name: “˜class”, or something else using a forbidden name format within the JAVA programming language, to avoid naming conflicts). The object instance's class could be stored in the DECLARING_CLASS column 1308, or the class' name could be stored in the data value column 1312 called V_STRING.

A member's value may be mapped to one of the data table's data value columns 1312 and stored in that column. Accordingly, a value of type Byte it is stored in V_BYTE of type SMALLINT. A value of type Character is stored in V_CHARACTER of type NCHAR (1). A value of type Short is stored in V_SHORT of type SMALLINT. A value of type Integer is stored in V_INTEGER of type INTEGER. A value of type Long is stored in V_LONG of type BIGINT. A value of type Float is stored in V_FLOAT of type REAL. A value of type Boolean is stored in V_BOOLEAN of type BIT. In some embodiments, for example, the mapping may be based on the following JDBC 4.2 standard (Table 2):

TABLE 2

| Java Type | JDBC Type |
|---|---|
| String | CHAR, VARCHAR, LONGVARCHAR, |
| | NCHAR, NVARCHAR or |
| | LONGNVARCHAR |
| java.math.BigDecimal | NUMERIC |
| boolean | BIT or BOOLEAN |
| byte | TINYINT |
| short | SMALLINT |
| int | INTEGER |
| long | BIGINT |
| float | REAL |
| double | DOUBLE |
| byte[ ] | BINARY, VARBINARY, or |
| | LONGVARBINARY |
| java.sql.Date | DATE |
| java.sql.Time | TIME |
| java.sql.Timestamp | TIMESTAMP |
| java.sql.Clob | CLOB |
| java.sql.Blob | BLOB |
| java.sql.Array | ARRAY |
| java.sql.Struct | STRUCT |
| java.sql.Ref | REF |
| java.net.URL | DATALINK |
| Java class | JAVA_OBJECT |
| java.sql.RowId | ROWID |
| java.sql.NClob | NCLOB |
| java.sql.SQLXML | SQLXML |

END TABLE 2

A value of type Handle: A handle is a wrapped object id (as described earlier). Accordingly, values of type Handle may be stored by taking the wrapped object id and storing it in one of the data value columns 1312 called V_OBJECT_ID of type BIGINT (the same type as column OBJECT_ID) or any other type able to store a unique identifier).

As mentioned above, string instances may be stored as if they have one artificial member named “˜value” of type String. These instances of String objects may be referred like other objects using handles in the intermediate data structure. Accordingly, in some embodiments, a member value of type String is a JAVA object and thus is stored as an object reference (a string might be referenced by several different object instances). The V_OBJECT_ID of a member of type String will contain the object id of the related String object instance. For example, String instances may be stored as if they each have a member named “˜value” of type String stored in one of the data value columns 1312 call V_STRING of type LONGNVARCHAR to allow national character strings of any length.

Consider, for example, the Customer instance 1112 as represented in data table 1300. The value “John” for the firstname member may be treated as a String object, which can be represented in the data table 1300 as object id “3”. Similarly the lastname, street, and city members in the Customer instance 1112 can be assigned respective object ids of “4”, “5”, and “6”. Accordingly, the V_OBJECT_ID data value columns 1312 of the member records for firstname, lastname, street, and city are respectively, “3”, “4”, “5”, and “6”.

Listing 6 (lines 1-33) below illustrates an example of Java code that may be used to persist an incoming intermediate data structure (e.g., 1202, FIG. 12A) in data table 1300 in accordance with a particular embodiment. An input to the code is objectId, which uniquely identifies the incoming intermediate data structure among other intermediate data structures created in an application. Another input to the code is an array of Member instances (Member[ ] member), which represents the member records (e.g., 1222, 1224, 1226) of the incoming intermediate data structure to be persisted. The JDBC prepared statement stmtInsertMember inserts a record into the database. The prepared statement “collects” all the necessary values/parmeters (in the stmtInsertMember.set*( ) commands) until it finally gets executed (stmtInsertMember.execute( )) and an SQL statement as follows gets performed: INSERT INTO MEMBER VALUES (value1, value2, value3, . . . ).

The for loop (lines 2-31) in Listing 6 processes each member record of the incoming intermediate data structure, adding each member record into a row in the data table 1300. The number of member records may be provided in members.length. The type of data that is stored in the member record is identified in (line 4). The methods in (lines 5-9) of the class stmtInsertMember store the objet id, the member name, the class, the declaring class, and the data type of the member record in respective columns 1302, 1304, 1306, 1308, and 1310 of the data table 1300.

An if statement (lines 10-30) determines where in the data table 1300 to store the value of the member record based on the data type identified in (line 4). For example at (line 12-13), a Byte data value is stored in the V_BYTE data value column 1312 of the data table 1300 using the setByteValue method.

After each member record has been inserted into a corresponding row in the data table 1300, the data table may be written to a storage device in (line 32) such as a hard disk drive or other suitable non-volatile storage. In particular, the new rows, which now contain data comprising the intermediate data structure, may be added to an existing data table file (not shown) that is on the storage device. In this way, the intermediate data structures in an application may be collected in a single data table that is stored in a data table file on a storage device.

LISTING 6

| | |
|---|---|
| 1 | public void insert(long objectId, Class class, Member[ ] members) { |
| 2 | |
| 3 | for (int i = 0; i < members.length; i++) { |
| 4 | short type = members[i].getType( ); |
| 5 | stmtInsertMember.setObjectId(objectId); |
| 6 | stmtInsertMember.setName(members[i].getName( )); |
| 7 | stmtInsertMember.setClass(class); |
| 8 | stmtInsertMember.setDeclaringClassName(members[i].getDeclaringClassName( )); |
| 9 | stmtInsertMember.setType(members[i].getType( )); |
| 10 | if (type == CLSID_HANDLE) { |
| 11 | stmtInsertMember.setObjectIdValue(members[i].getValue( ).to_objectId( )); |
| 12 | } else if (type == CLSID_BYTE) { |
| 13 | stmtInsertMember.setByteValue(members[i].getValue( )); |
| 14 | } else if (type == CLSID_CHARACTER) { |
| 15 | stmtInsertMember.setCharacterValue(members[i].getValue( )); |
| 16 | } else if (type == CLSID_SHORT) { |
| 17 | stmtInsertMember.setShortValue(members[i].getValue( )); |
| 18 | } else if (type == CLSID_INTEGER) { |
| 19 | stmtInsertMember.setIntegerValue(members[i].getValue( )); |
| 20 | } else if (type == CLSID_LONG) { |
| 21 | stmtInsertMember.setLongValue(members[i].getValue( )); |
| 22 | } else if (type == CLSID_DOUBLE) { |
| 23 | stmtInsertMember.setDoubleValue(members[i].getValue( )); |
| 24 | } else if (type == CLSID_FLOAT) { |
| 25 | stmtInsertMember.setFloatValue(members[i].getValue( )); |
| 26 | } else if (type == CLSID_BOOLEAN) { |
| 27 | stmtInsertMember.setBooleanValue(members[i].getValue( )); |
| 28 | } else if (type == CLSID_STRING) { |
| 29 | stmtInsertMember.setStringValue(members[i].getValue( )); |
| 30 | } |
| 31 | } |
| 32 | stmtInsertMember.execute( ); |
| 33 | +56 |

END LISTING 6

Listing 7 (lines 1-48) below illustrates an example of Java code that may be used to rebuild an intermediate data structure (e.g., 1202, FIG. 12A) from the data table 1300 in accordance with a particular embodiment. For example, after the data table 1300 has been loaded from a data table file stored on a storage device, the data table may contain several previously persisted intermediate data structures. The following code may be used to rebuild a specified intermediate data structure from the data table 1300. An input to the code is the objectId, which specifies the intermediate data structure. The code will return an array of instances of the Member class, containing member instances which comprise the specified intermediate data structure.

The rows which store the member records that comprise the specified intermediate data structure may be retrieved in (line 4) using the objectId, which identifies the specified intermediate data structure. An instance list of class ArrayList will store data, extracted from the data table 1300, comprising the specified intermediate data store.

The loop (lines 5-46) is performed for each of the rows retrieved in (line 4). For each row, the member name, its declaring class, and its data type are retrieved in (lines 7-9) from the data table 1300. The switch statement (lines 11-44) accesses one of the data value columns 1312 of the data table 1300 according the data type obtained in (line 9). The data are then added to the ArrayList instance list in (line 45).

When all the member records of the specified intermediate data structure have been retrieved, the ArrayList instance list—converted to an array of instances of the Member class—is returned.

LISTING 7

| | |
|---|---|
| 1 | public Member[ ] retrieve(long objectId) { |
| 2 | ArrayList list = new ArrayList( ); |
| 3 | stmtSelectAllMembers.setObjectId(objectId); |
| 4 | ResultSet rs = stmtSelectAllMembers.execute( ); |
| 5 | if (rs.next( )) { |
| 6 | do { |
| 7 | String name = get_Column_NAME(rs); |
| 8 | String declaringClassName = |

getColumn_DECLARING_CLASS(rs);

| | |
|---|---|
| 9 | short typeId = getColunm_TYPE(rs); |
| 10 | Object value = null; |
| 11 | switch (typeId) { |
| 12 | case CLSID_HANDLE: |
| 13 | value = new Handle(getColumn_V_OBJECT_ID(rs)); |
| 14 | break; |
| 15 | case CLSID_BYTE: |
| 16 | value = getColumn_V_BYTE(rs); |
| 17 | break; |
| 18 | case CLSID_CHARACTER: |
| 19 | value = getColumn_V_CHARACTER(rs); |
| 20 | break; |
| 21 | case CLSID_SHORT: |
| 22 | value = getColumn_V_SHORT(rs); |
| 23 | break; |
| 24 | case CLSID_INTEGER: |
| 25 | value = getColumn_V_INTEGER(rs); |
| 26 | break; |
| 27 | case CLSID_LONG: |
| 28 | value = getColumn_V_LONG(rs); |
| 29 | break; |
| 30 | case CLSID_DOUBLE: |
| 31 | value = getColumn_V_DOUBLE(rs); |
| 32 | break; |
| 33 | case CLSID_FLOAT: |
| 34 | value = getColumn_V_FLOAT(rs); |
| 35 | break; |
| 36 | case CLSID_BOOLEAN: |
| 37 | value = getColumn_V_BOOLEAN(rs); |
| 38 | break; |
| 39 | case CLSID_STRING: |
| 40 | value = getColumn_V_STRING(rs); |
| 41 | break; |
| 42 | default: |
| 43 | throw new RuntimeException(“unknown class id”); |
| 44 | } |
| 45 | list.add(new Member(name, declaringClassName, value)); |
| 46 | } while (rs.next( )); |
| 47 | return (Member[ ]) list.toArray(...); |
| 48 | } |

END LISTING 7

Listing 8 (lines 1-6) below illustrates an example of Java code that may be used to identify the class of an intermediate data structure (e.g., 1202, FIG. 12A) from the data table 1300 in accordance with a particular embodiment. An input to the code, objectId, uniquely identifies the intermediate data structure of interest. One of the member records of the intermediate data structure of interest is retrieved from the data table 1300 (line 3). In an embodiment, the first member record may be retrieved, though any member record would do. The CLASS column 1302 is extracted (line 4) and returned (line 5).

LISTING 8

1 public Class getClass(long objectId) {
2
3 ResultSet rs = stmtSelectFirstMember(objectId);
4 Class class = getColumn_CLASS(rs);
5 return class;
6 }

END OF LISTING 8

The above description illustrates various embodiments of the present disclosure along with examples of how aspects of the particular embodiments may be implemented. The above examples should not be deemed to be the only embodiments, and are presented to illustrate the flexibility and advantages of the particular embodiments as defined by the following claims. Based on the above disclosure and the following claims, other arrangements, embodiments, implementations and equivalents may be employed without departing from the scope of the present disclosure as defined by the claims.

We claim the following:

1. A method for persisting objects comprising operating a computer system to perform steps of:
scanning an object to identify members of the object;
generating an intermediate data structure that represents the object, the intermediate data structure comprising a member record for each constituent member of the object, the member record comprising at least a member name that represents a name of said each constituent member, a member value of said each constituent member, and a member type indicative of a data type of the member value of said each constituent member; and
persisting the intermediate data structure including storing the member records comprising the intermediate data structure in a single data table file, the single data table file comprising:
a plurality of rows, each row containing data comprising one of the member records; and
a plurality of columns including a first column to store data representative of member names of the member records, a second column to store data representative of member types of the member records, and a plurality of value columns, each value column defined to store data of a given data type.

2. The method of claim 1 wherein each member record of the intermediate data structure is stored in a corresponding row of the single data table file, wherein the member name and member type of said each member record are represented by data stored in respective first and second columns of the corresponding row, wherein the member value of said each member record is stored in only one of the value columns of the corresponding row.

3. The method of claim 1 wherein the object is one object in an object closure, the method further comprising repeating the scanning, generating, and persisting steps for other objects comprising the object closure.

4. The method of claim 3 wherein each object in the object closure is represented by a corresponding intermediate data structure, wherein each corresponding intermediate data structure is persisted in the single data table file.

5. The method of claim 1 wherein the single data table file further comprises a column to store an identifier that identifies an object class of each constituent member and a column to store an identifier that identifies a declaring class to identify each constituent member's inheritance to other objects.

6. The method of claim 1 wherein the single data table file further comprises a column to store a unique identifier that is associated with each instance of an object that is represented in an intermediate data structure that is persisted in the single data table file.

7. The method of claim 1 further comprising creating the single data table file in a database.

8. The method of claim 7 further comprising invoking a CREATE TABLE SQL statement to create the single data table file.

9. The method of claim 1 further comprising storing the single data table file in a non-volatile storage system of a database system.

10. A system comprising:
a data processor; and
a storage device having stored thereon computer executable program code, which, when executed by the data processor, causes the data processor to:
scan an object to identify members of the object;
generate an intermediate data structure that represents the object, the intermediate data structure comprising at least a member record for each constituent member of the object, the member record comprising a member name that represents a name of said each constituent member, a member value of said each constituent member, and a member type indicative of a data type of the member value of said each constituent member; and
persist the intermediate data structure including storing the member records comprising the intermediate data structure in a single data table file, the single data table file comprising:
a plurality of rows, each row containing data comprising one of the member records; and
a plurality of columns including a first column to store data representative of member names of the member records, a second column to store data representative of member types of the member records, and a plurality of value columns, each value column defined to store data of a given data type.

11. The system of claim 10 wherein each member record of the intermediate data structure is stored in a corresponding row of the single data table file, wherein the member name and member type of said each member record are represented by data stored in respective first and second columns of the corresponding row, wherein the member value of said each member record is stored in only one of the value columns of the corresponding row.

12. The system of claim 10 wherein the object is one object in an object closure, wherein other objects comprising the object closure is scanned and persisted.

13. The system of claim 10 wherein each object in the object closure is represented by a corresponding intermediate data structure, wherein each corresponding intermediate data structure is persisted in the single data table file.

14. The system of claim 10 wherein the single data table file further comprises a column to store an identifier that identifies an object class of each constituent member and a column to store an identifier that identifies a declaring class to identify each constituent member's inheritance to other objects.

15. The system of claim 10 wherein the single data table file further comprises a column to store a unique identifier that is associated with each instance of an object that is represented in an intermediate data structure that is persisted in the single data table file.

16. A non-transitory computer readable storage medium having stored thereon computer executable program code, which, when executed by a computing device, causes the computing device to perform steps of:
scanning an object to identify members of the object;
generating an intermediate data structure that represents the object, the intermediate data structure comprising at least a member record for each constituent member of the object, the member record comprising a member name that represents a name of said each constituent member, a member value of said each constituent member, and a member type indicative of a data type of the member value of said each constituent member; and
persisting the intermediate data structure including storing the member records comprising the intermediate data structure in a single data table file, the single data table file comprising:
a plurality of rows, each row containing data comprising one of the member records; and
a plurality of columns including a first column to store data representative of member names of the member records, a second column to store data representative of member types of the member records, and a plurality of value columns, each value column defined to store data of a given data type.

17. The non-transitory computer readable storage medium of claim 16 wherein each member record of the intermediate data structure is stored in a corresponding row of the single data table file, wherein the member name and member type of said each member record are represented by data stored in respective first and second columns of the corresponding row, wherein the member value of said each member record is stored in only one of the value columns of the corresponding row.

18. The non-transitory computer readable storage medium of claim 16 wherein the object is one object in an object closure, the method further comprising repeating the scanning, generating, and persisting steps for other objects comprising the object closure.

19. The non-transitory computer readable storage medium of claim 18 wherein each object in the object closure is represented by a corresponding intermediate data structure, wherein each corresponding intermediate data structure is persisted in the single data table file.

20. The non-transitory computer readable storage medium of claim 16 wherein the single data table file further comprises a column to store a unique identifier that is associated with each instance of an object that is represented in an intermediate data structure that is persisted in the single data table file.
